(19) United States
(12) Patent Application Publication
(10) Pub. No.: US 2016/0165913 A1
(43) Pub. Date: Jun. 16, 2016

(54) FAT COMPOSITION

(71) Applicant: KAO CORPORATION, Tokyo (JP)

(72) Inventors: Yuumi MATSUDA, Sumida-ku (JP); Rika HOMMA, Sumida-ku (JP)

(73) Assignee: KAO CORPORATION, Chuo-ku, Tokyo (JP)

(21) Appl. No.: 14/892,302

(22) PCT Filed: May 19, 2014
(86) PCT No.: PCT/JP2014/063233

§ 371 Date: Nov. 19, 2015

(30) Foreign Application Priority Data
May 20, 2013 (JP) 2013-106205
May 20, 2013 (JP) 2013-106206

(51) Int. Cl. A23D 9/007

(52) U.S. Cl. CPC A23D 9/007

(57) ABSTRACT

Provided is a fat or oil composition having high oxidative stability while containing a large amount of α-linolenic acid, and having suppressed degradation odor and unpleasant odor derived from a rosemary extract at the time of cooking. The fat or oil composition includes the following components (A), (B), and (C1): (A) a fat or oil in which a content of α-linolenic acid in constituent fatty acids of the fat or oil is from 15 to 60 mass %; (B) a rosemary extract at a content of from 0.005 to 0.25 mass %; and (C1) a thyme extract, a basil extract, or a combination thereof at a content of from 0.00001 to 0.0025 mass %.

### FIELD OF THE INVENTION

The present invention relates to a fat or oil composition.

### BACKGROUND OF THE INVENTION

Many investigations have been made on functions of fatty acids in fats or oils in response to increasing health consciousness in recent years. For example, it is known that ω3 highly-unsaturated fatty acids such as α-linolenic acid, eicosapentaenoic acid, and docosahexaenoic acid have prevention effects against coronary artery disease, cerebral stroke, and the like. Further, those fatty acids cannot be synthesized in a living human body, shortage of the fatty acids leads to onset of dermatitis and the like, and hence use of fats or oils containing the fatty acids has been desired. In 2005, the Japanese Ministry of Health, Labour and Welfare defined a recommended total intake (adult) of ω3 highly-unsaturated fatty acids including α-linolenic acid as 1 g/day.

Meanwhile, a fat or oil rich in α-linolenic acid has very low oxidative stability and is liable to produce deterioration odor and unpleasant odor/taste, and hence practical use thereof is remarkably restricted.

As technologies for improving oxidative stability of a fat or oil, there has been known, for example, a method involving adding a tocopherol to Lamiaceae oil (Patent Document 1), and a method involving adding a roasted sesame oil, an ascorbic acid ester, and an herb extract to a fat or oil containing a polyunsaturated fatty acid to stabilize the fat or oil (Patent Document 2).

Further, as an antioxidant, there have been known a lipophilic antioxidant containing, for example, a bayberry extract and a rosemary extract (Patent Document 3), a lipophilic antioxidant containing gallic acid, a water-soluble antioxidant, and an oil-soluble antioxidant (Patent Document 4), and an antioxidant composition including an acetone extract of tea leaves together with a tocopherol, and an ascorbic acid ester (Patent Document 5). In addition, the rosemary extract has been known to have a high antioxidative property (Non Patent Document 1), an antioxidant including a rosemary extract that includes hexanal, carnosol, and carnosic acid in specified amounts (Patent Document 6), and the like have been reported.

### CITATION LIST

### Patent Document

[Patent Document 1] JP-A-H08-116878
[Patent Document 2] JP-A-H02-189394
[Patent Document 3] JP-A-2007-185138
[Patent Document 4] JP-A-2002-142673
[Patent Document 5] JP-A-H02-55785
[Patent Document 6] JP-A-2004-204212

### Non Patent Document

[Non Patent Document 1] “Agric. Food Chem.”, 1996, Vol. 44, No. 1, p. 131-135

### SUMMARY OF THE INVENTION

The present invention provides a fat or oil composition, comprising the following components (A), (B), and (C1):

(A) a fat or oil in which a content of α-linolenic acid in constituent fatty acids of the fat or oil is from 15 to 60 mass %;

(B) a rosemary extract at a content of from 0.005 to 0.25 mass %; and

(C1) a thyme extract, a basil extract, or a combination thereof at a content of from 0.00001 to 0.0025 mass %.

The present invention provides a fat or oil composition, comprising the following components (A), (B), and (C2):

(A) a fat or oil in which a content of α-linolenic acid in constituent fatty acids of the fat or oil is from 15 to 60 mass %;

(B) a rosemary extract at a content of from 0.005 to 0.25 mass %; and

(C2) one or two or more selected from the group consisting of a clove extract, an oregano extract, and a bay laurel extract at a content of from 0.00001 to 0.001 mass %.

### DETAILED DESCRIPTION OF THE INVENTION

However, the technologies described above have a problem in that degradation odor is liable to be produced because of an insufficient antioxidative property at the time of heating. Also, a plant extract, in particular, a rosemary extract has an excellent antioxidative property but has very strong flavor, and hence original taste and flavor of a cooked food is hardly sensed when a fat or oil containing the rosemary extract is used for cooking. Therefore, the amount of the fat or oil to be added is inevitably restricted, and it is difficult to improve oxidative stability of the fat or oil.

Therefore, the present invention relates to providing a fat or oil composition having high oxidative stability while containing a large amount of α-linolenic acid, and having suppressed degradation odor and unpleasant odor derived from a rosemary extract at the time of cooking.

The inventors of the present invention made intensive investigations. As a result, the inventors found that incorporation of a combination of a rosemary extract and a specific plant extract into a fat or oil was able to impart high oxidative stability, to suppress degradation odor at the time of cooking, and to suppress strong odor derived from rosemary, to thereby provide a fat or oil composition enabling good taste and flavor of a cooked food or the like to be sensed.

According to the present invention, there is provided a fat or oil composition that has high oxidative stability while containing a large amount of α-linolenic acid, has degradation odor and strong unpleasant odor derived from rosemary at the time of cooking both suppressed, and is capable of providing a cooked food excellent in taste and flavor.

The content of a fat or oil as a component (A) of the present invention in the fat or oil composition is preferably from 95 to 99.95 mass % (hereinafter simply referred to as “%”), more preferably from 97 to 99%, from the viewpoint of the use thereof.

In the constituent fatty acids of the fat or oil as the component (A) to be used in the present invention, the content of α-linolenic acid is 15% or more and 60% or less, that is, from 15 to 60%, and is preferably 17% or more, more preferably 20% or more, from the viewpoint of physiological effects. Further, the content of α-linolenic acid is preferably 55% or less, more preferably 50% or less, more preferably 45% or less, more preferably 40% or less, more preferably 30% or less, even more preferably 25% or less, from the viewpoint of oxidative stability. The content of α-linolenic acid in the constituent fatty acids of the fat or oil as the component (A) is preferably from 15 to 50%, more preferably from 15 to 40%, more preferably from 15 to 30%, even more preferably from 15 to 25%, from the viewpoints of both physiological effects and oxidative stability. It should be noted that the amount of a fatty acid herein refers to an amount obtained by converting it to a free fatty acid.

The constituent fatty acids of the fat or oil as the component (A) other than α-linolenic acid are not particularly limited and may be any of saturated fatty acids and unsaturated fatty acids. The ratio of the unsaturated fatty acids in the constituent fatty acids of the fat or oil other than α-linolenic acid is preferably from 60 to 100%, more preferably from 70 to 100%, more preferably from 75 to 100%, even more preferably from 80 to 98%, from the viewpoints of appearance and the industrial productivity of the fat or oil. The carbon numbers of the unsaturated fatty acids are preferably from 14 to 24, more preferably from 16 to 22, from the viewpoint of physiological effects.

In addition, the content of the saturated fatty acids of the constituent fatty acids of the fat or oil as the component (A) is preferably 40% or less, more preferably 30% or less, more preferably 25% or less, even more preferably 20% or less from the viewpoints of appearance and physiological effects. Further, the content is preferably 0.5% or more, from the viewpoint of the industrial productivity of the fat or oil. The carbon numbers of the saturated fatty acids are preferably from 14 to 24, more preferably from 16 to 22.

In the present invention, substances constituting the fat or oil as the component (A) include monoacylglycerols and diacylglycerols as well as triacylglycerols. That is, the fat or oil as the component (A) in the present invention contains any one or more of monoacylglycerols, diacylglycerols, and triacylglycerols.

The content of the triacylglycerols in the fat or oil as the component (A) is preferably from 78 to 100%, more preferably from 88 to 100%, more preferably from 90 to 99.5%, even more preferably from 92 to 99%, from the viewpoint of the industrial productivity of the fat or oil.

Further, the content of the diacylglycerols in the fat or oil as the component (A) is preferably 19% or less, more preferably 9% or less, more preferably from 0.1 to 7%, even more preferably from 0.2 to 5%, from the viewpoint of the industrial productivity of the fat or oil. Moreover, the content of the monoacylglycerols in the fat or oil as the component (A) is preferably 3% or less, more preferably from 0 to 2%, from the viewpoint of improvement of taste and flavor.

In addition, the content of a free fatty acid or a salt thereof contained in the fat or oil composition of the present invention is preferably 5% or less, more preferably from 0 to 2%, even more preferably from 0 to 1%, from the viewpoints of the taste and flavor and the industrial productivity of the fat or oil.

An edible fat or oil that may be used as an origin of the fat or oil as the component (A) of the present invention is not particularly limited, and examples thereof may include the following fats or oils: plant-derived fats or oils such as soybean oil, rapeseed oil, safflower oil, rice oil, corn oil, sunflower oil, cotton seed oil, olive oil, sesame oil, peanut oil, Job's tears seed oil, wheat germ oil, Japanese basil oil, linseed oil, perilla oil, sacha inchi oil, walnut oil, kiwi seed oil, salvia seed oil, grape seed oil, macadamia nut oil, hazelnut oil, pumpkin seed oil, camellia oil, tea seed oil, borage oil, palm oil, palm olein, palm stearin, coconut oil, palm kernel oil, cacao fat, sal fat, shea fat, and algae oil; animal-derived fats or oils such as fish oil, lard, beef tallow, and butter fat; and transesterified oils, hydrogenated oils, and fractionated oils thereof, or the like. The oils may each be used singly or may be mixed appropriately before use. Of those, from the viewpoint of usability, plant-derived fats or oils are preferably used, a liquid fat or oil excellent in low-temperature resistance is more preferably used, and one or two or more selected from the group consisting of Japanese basil oil, linseed oil, and perilla oil are even more preferably used because the oils are rich in α-linolenic acid. It should be noted that the liquid fat or oil refers to a fat or oil that stays liquid at 20° C., when determined in accordance with a cold test described in Standard Methods for the Analysis of Fats, Oils and Related Materials 2.3.8-27. In addition, the edible fat or oil is preferably a refined fat or oil obtained by a refinement step.

A rosemary extract as a component (B) to be used in the present invention refers to an extract of rosemary (Japanese name: Mannenrou) belonging to the genus Rosmarinus of the family Lamiaceae (Rosmarinus officinalis L.). Known varieties of the rosemary include Brenenden Blue, Creeping, Marine Blue, Majolica pink, Tuscan Blue, and Rex, or the like. In the present invention, all of the varieties may be used.

The part of the rosemary to be used for preparing the rosemary extract as the component (B) is not particularly limited, and examples thereof include leaf, stem, germ, flower, branch, root, and seed or the like, and a mixture thereof. The parts may be subjected to an extraction step without additional treatment, or may be subjected thereto after pulverization, cutting, or drying.

As extraction means for preparing an extract, there may be used any means such as solid-liquid extraction, liquid-liquid extraction, immersion, decoction, leaching, steam distillation, reflux extraction, sonication extraction, microwave extraction, or stirring.

A solvent for extraction is not particularly limited, and examples thereof include: water; steam; an alcohol such as methanol or ethanol; subcritical or supercritical carbon dioxide; an edible fat or oil such as soybean oil, rapeseed oil, sunflower oil, palm oil, or lard; and a mixture thereof.

In addition, as the rosemary extract as the component (B), there may be used a commercially available product, preferably one commercially available as an antioxidant, more preferably one commercially available as an antioxidant for foods and beverages.

The rosemary extract as the component (B) may be a crude product as long as the extract meets the standard acceptable for foods and exerts the effects of the present invention to be exhibited. The resultant crude product may further be purified by using known separation and purification methods in appropriately combination. As purification means, there are given, for example, precipitation with an organic solvent, centrifugation, ultrafiltration, treatment with an adsorbent, high-performance liquid chromatography, and column chromatography.

The content of the rosemary extract as the component (B) in the fat or oil composition is 0.005% or more and 0.25% or less, that is, from 0.005 to 0.25%, and is preferably 0.01% or more, more preferably 0.02% or more, even more preferably 0.03% or more, from the viewpoint of oxidative stability. In addition, the content of the rosemary extract as the component (B) in the fat or oil composition is preferably 0.2% or less, more preferably 0.17% or less, more preferably 0.16% or less, even more preferably 0.15% or less, from the viewpoint of taste and flavor. The content of the rosemary extract as the component (B) in the fat or oil composition is preferably from 0.005 to 0.25%, more preferably from 0.01 to 0.25%, more preferably from 0.01 to 0.2%, more preferably from 0.02 to 0.17%, even more preferably from 0.03 to 0.15%, from the viewpoints of both oxidative stability and taste and flavor.

In the case where the content of α-linolenic acid in the constituent fatty acids of the fat or oil as the component (A) is 30% or more, the content of the rosemary extract as the component (B) in the fat or oil composition is preferably from 0.016 to 0.1%.

Further, in the case where the content of α-linolenic acid in the constituent fatty acids of the fat or oil as the component (A) is 40% or more, the content of the rosemary extract as the component (B) in the fat or oil composition is preferably from 0.04 to 0.1%.

In the fat or oil composition of the present invention, a ratio (content mass ratio) of the content of the rosemary extract as the component (B) in the fat or oil composition to the content of α-linolenic acid in the constituent fatty acids of the fat or oil as the component (A), [(B)/(C18:3)], is preferably 0.0002 or more, more preferably 0.0005 or more, more preferably 0.001 or more, even more preferably 0.0015 or more, from the viewpoint of oxidative stability. Further, the ratio is preferably 0.015 or less, more preferably 0.01 or less, from the viewpoint of taste and flavor. The ratio of the content of the rosemary extract as the component (B) in the fat or oil composition to the content of α-linolenic acid in the constituent fatty acids of the fat or oil as the component (A), [(B)/(C18:3)], is preferably from 0.0002 to 0.015, more preferably from 0.0005 to 0.01, more preferably from 0.001 to 0.01, even more preferably from 0.0015 to 0.01, from the viewpoints of both oxidative stability and taste and flavor.

A thyme extract as a component (C1) to be used in the present invention is an extract of Thymus vulgaris L. (alias: thyme) belonging to the genus Thymus. In addition, a basil extract is an extract of basil (Ocimumbasilicum L.) belonging to the genus Ocimum.

In the present invention, the thyme extract and the basil extract may each be used alone or may be used in combination. Hereinafter, “a thyme extract, a basil extract, or a combination thereof” is sometimes simply referred to as component (C1).

The part of a plant to be used for preparing the component (C1) is not particularly limited, and examples thereof include leaf, stem, germ, flower, branch, root, fruit, and seed or the like, and a mixture thereof. The parts may be subjected to an extraction step without additional treatment, or may be subjected thereto after pulverization, cutting, or drying.

Extraction means for preparing the component (C1), a purification method for a solvent for extraction, and the like are the same as those of the rosemary extract as the component (B).

In addition, as the component (C1), there may be used a commercially available product, preferably one commercially available as a product for foods.

A content of the component (C1) in the fat or oil composition is 0.00001% or more and 0.0025% or less, that is, from 0.00001 to 0.0025%, and is preferably 0.00002% or more, more preferably 0.00004% or more, more preferably 0.0001% or more, even more preferably 0.0002% or more, from the viewpoint of suppression of odor derived from the rosemary extract. In addition, the content of the component (C1) in the fat or oil composition is preferably 0.002% or less, more preferably 0.0018% or less, more preferably 0.0015% or less, more preferably 0.0012% or less, more preferably 0.0009% or less, even more preferably 0.0007% or less, from the viewpoint of taste and flavor. The content of the component (C1) is preferably from 0.00001 to 0.002%, more preferably from 0.00002 to 0.002%, more preferably from 0.00002 to 0.0018%, more preferably from 0.00002 to 0.0015%, more preferably from 0.00002 to 0.0009%, more preferably from 0.00002 to 0.0007%, more preferably from 0.00004 to 0.0007%, more preferably from 0.0001 to 0.0007%, even more preferably from 0.0002 to 0.0007%, from the viewpoints of both suppression of odor derived from the rosemary extract, and taste and flavor.

In the case where the content of α-linolenic acid in the constituent fatty acids of the fat or oil as the component (A) is 30% or more, further 40% or more, the content of the component (C1) in the fat or oil composition is preferably 0.0001% or more.

It should be noted that in the present invention, the rosemary extract as the component (B), and the thyme extract and the basil extract as the component (C1) may have a purity of about 100% or may be diluted with a solvent used for extraction. The content of the rosemary extract as the component (B) or the content of the component (C1) in the present invention is determined based on the mass of a pure substance containing no solvent.

In the fat or oil composition of the present invention, the ratio (content mass ratio) of the content of the component (C1) to the content of the component (B), [(C1)/(B)], is preferably 0.0003 or more, more preferably 0.0004 or more, more preferably 0.001 or more, even more preferably 0.002 or more, from the viewpoint of suppression of odor derived from the rosemary extract, and the ratio is preferably 0.08 or less, more preferably 0.05 or less, more preferably 0.03 or less, more preferably 0.019 or less, more preferably 0.018 or less, even more preferably 0.017 or less, from the viewpoints of suppression of odor derived from the component (C1), and taste and flavor. Further, in the fat or oil composition, the ratio of the content of the component (C1) to the content of the component (B), [(C1)/(B)], is preferably from 0.0003 to 0.08, more preferably from 0.0004 to 0.05, more preferably from 0.0004 to 0.03, more preferably from 0.001 to 0.03, more preferably from 0.002 to 0.03, more preferably from 0.002 to 0.019, more preferably from 0.002 to 0.018, even more preferably from 0.002 to 0.017, from the viewpoints of both suppression of odor derived from the component (C1), taste and flavor, and suppression of odor derived from the rosemary extract.

A clove extract as a component (C2) to be used in the present invention is an extract of a clove (Syzygium aromaticum L.), which belongs to the genus Eugenia of the family Myrtaceae. Further, an oregano extract is an extract of an oregano (Origanum vulgare L.), which belongs to the genus Origanum of the family Lamiaceae. Further, a bay laurel extract is an extract of a bay laurel (Laurus nobilis L.), which belongs to the genus Laurus of the family Lauraceae.

In the present invention, one selected from the group consisting of the clove extract, the oregano extract, and the bay laurel extract may be used alone or two or more thereof may be used in combination. Hereinafter, “one or two or more selected from the group consisting of a clove extract, an oregano extract, and a bay laurel extract” are sometimes simply referred to as component (C2).

Further, in the present invention, two or more selected from the group consisting of the thyme extract, the basil extract, the clove extract, the oregano extract, and the bay laurel extract may be used in combination.

The part of a plant to be used for preparing the component (C2) is not particularly limited, and examples thereof include leaf, stem, germ, flower, branch, root, fruit, and seed or the like, and a mixture thereof. The parts may be subjected to an extraction step without additional treatment, or may be subjected thereto after pulverization, cutting, or drying.

Extraction means for preparing the component (C2), a purification method for a solvent for extraction, and the like are the same as those of the rosemary extract as the component (B).

In addition, as the component (C2), there may be used a commercially available product, preferably one commercially available as a product for foods.

A content of the component (C2) in the fat or oil composition is 0.00001% or more and 0.001% or less, that is, from 0.00001 to 0.001%, and is preferably 0.00002% or more, more preferably 0.00005% or more, even more preferably 0.0001% or more, from the viewpoint of suppression of odor derived from the rosemary extract. In addition, the content of the component (C2) in the fat or oil composition is preferably 0.0009% or less, more preferably 0.0008% or less, even more preferably 0.0005% or less, from the viewpoint of taste and flavor. The content of the component (C2) is preferably from 0.00001 to 0.0009%, more preferably from 0.00002 to 0.0009%, more preferably from 0.00002 to 0.0008%, more preferably from 0.00005 to 0.0005%, even more preferably from 0.0001 to 0.0005%, from the viewpoints of both suppression of odor derived from the rosemary extract, and taste and flavor.

Further, the content of the clove extract in the fat or oil composition is preferably from 0.00001 to 0.0009%, more preferably from 0.00002 to 0.0008%, even more preferably from 0.00005 to 0.0005%, from the viewpoints of both suppression of odor derived from the rosemary extract, and taste and flavor.

Further, the content of the oregano extract in the fat or oil composition is preferably from 0.0001 to 0.0009%, more preferably from 0.0001 to 0.0005%, even more preferably from 0.0001 to 0.0003%, from the viewpoints of both suppression of odor derived from the rosemary extract, and taste and flavor.

Further, the content of the bay laurel extract in the fat or oil composition is preferably from 0.0001 to 0.0009%, more preferably from 0.0001 to 0.0005%, even more preferably from 0.0001 to 0.0003%, from the viewpoints of both suppression of odor derived from the rosemary extract, and taste and flavor.

In the case where the content of α-linolenic acid in the constituent fatty acids of the fat or oil as the component (A) is 30% or more, further 40% or more, the content of the component (C2) in the fat or oil composition is preferably 0.0001% or more.

It should be noted that in the present invention, the clove extract, oregano extract, and bay laurel extract as the component (C2) may have a purity of about 100% or may be diluted with a solvent used for extraction. The content of the component (C2) in the present invention is determined based on the mass of a pure substance containing no solvent.

In the fat or oil composition of the present invention, a ratio (content mass ratio) of the content of the component (C2) to the content of the component (B), [(C2)/(B)], is preferably 0.0001 or more, more preferably 0.0004 or more, even more preferably 0.001 or more, from the viewpoint of suppression of odor derived from the rosemary extract, and the ratio is preferably 0.03 or less, more preferably 0.019 or less, more preferably 0.018 or less, even more preferably 0.007 or less, from the viewpoints of suppression of odor derived from the component (C2), and taste and flavor. Further, in the fat or oil composition, the ratio of the content of the component (C2) to the content of the component (B), [(C2)/(B)], is preferably from 0.0001 to 0.03, more preferably from 0.0001 to 0.018, even more preferably from 0.001 to 0.007, from the viewpoints of both suppression of odor derived from the component (C2), taste and flavor, and suppress ion of odor derived from the rosemary extract.

In addition, the fat or oil composition of the present invention contains preferably 0.01 to 0.2%, more preferably 0.02 to 0.1% of an antioxidant other than the component (B) and the components (C1) and (C2) in the fat or oil composition, from the viewpoint of oxidative stability at the time of each of storage and cooking. Examples of the antioxidant include a natural antioxidant, a tocopherol, and an ascorbic acid ester or the like. Of those, one or two or more of antioxidants selected from the group consisting of a natural antioxidant, a tocopherol, and ascorbyl palmitate are preferably used, and a combination of ascorbyl palmitate and a tocopherol is more preferably used.

The fat or oil composition of the present invention can be obtained by, for example, adding the components (B), (C1), and (C2), and other components, if necessary, to the fat or oil as the component (A) and optionally, for example, heating and stirring the resultant mixture.

Such fat or oil composition can be used in the same manner as a general edible fat or oil, and can be applied to a variety of foods and beverages including the fat or oil. In particular, the fat or oil composition is used suitably as a fat or oil for cooking, more suitably as a fat or oil for cooking of a deep-fried food such as fry or tempura, a sauteed food, or a grilled food.

In relation to the above-mentioned embodiments, the present invention discloses the following fat or oil compositions or uses.

<1> A fat or oil composition, comprising the following components (A), (B), and (C1):

(A) a fat or oil in which a content of α-linolenic acid in constituent fatty acids of the fat or oil is from 15 to 60 mass %;

(B) a rosemary extract at a content of from 0.005 to 0.25 mass %; and

(C1) a thyme extract, a basil extract, or a combination thereof at a content of from 0.00001 to 0.0025 mass %.

<2> The fat or oil composition according to the above-mentioned item <1>, in which the content of α-linolenic acid in the constituent fatty acids of the fat or oil as the component (A) is 15 mass % or more, more preferably 17 mass % or more, even more preferably 20 mass % or more.
<3> The fat or oil composition according to the above-mentioned item <1> or <2>, in which the content of α-linolenic acid in the constituent fatty acids of the fat or oil as the component (A) is 60 mass % or less, more preferably 55 mass % or less, more preferably 50 mass % or less, more preferably 45 mass % or less, more preferably 40 mass % or less, more preferably 30 mass % or less, even more preferably 25 mass % or less.
<4> The fat or oil composition according to the above-mentioned item <1>, in which the content of α-linolenic acid in the constituent fatty acids of the fat or oil as the component (A) is preferably from 15 to 50 mass %, more preferably from 15 to 40 mass %, more preferably from 15 to 30 mass %, even more preferably from 15 to 25 mass %.
<5> The fat or oil composition according to any one of the above-mentioned items <1> to <4>, in which the component (A) preferably includes one or two or more of fats or oils selected from the group consisting of linseed oil, Japanese basil oil, and perilla oil.
<6> The fat or oil composition according to any one of the above-mentioned items <1> to <5>, in which the content of the rosemary extract as the component (B) is 0.005 mass % or more, more preferably 0.01 mass % or more, more preferably 0.02 mass % or more, even more preferably 0.03 mass % or more.
<7> The fat or oil composition according to any one of the above-mentioned items <1> to <6>, in which the content of the rosemary extract as the component (B) is 0.25 mass % or less, more preferably 0.2 mass % or less, more preferably 0.17 mass % or less, more preferably 0.16 mass % or less, even more preferably 0.15 mass % or less.
<8> The fat or oil composition according to any one of the above-mentioned items <1> to <5>, in which the content of the rosemary extract as the component (B) is preferably from 0.01 to 0.25 mass %, more preferably from 0.01 to 0.2 mass %, more preferably from 0.02 to 0.17 mass %, even more preferably from 0.03 to 0.15 mass %.
<9> The fat or oil composition according to any one of the above-mentioned items <1> to <8>, in which the ratio (content mass ratio) of the content of the rosemary extract as the component (B) in the fat or oil composition to the content of α-linolenic acid in the constituent fatty acids of the fat or oil as the component (A), [(B)/(C18:3)], is preferably 0.0002 or more, more preferably 0.0005 or more, more preferably 0.001 or more, even more preferably 0.0015 or more.
<10> The fat or oil composition according to any one of the above-mentioned items <1> to <9>, in which the ratio (content mass ratio) of the content of the rosemary extract as the component (B) in the fat or oil composition to the content of α-linolenic acid in the constituent fatty acids of the fat or oil as the component (A), [(B)/(C18:3)], is preferably 0.015 or less, more preferably 0.01 or less.
<11> The fat or oil composition according to any one of the above-mentioned items <1> to <8>, in which the ratio (content mass ratio) of the content of the rosemary extract as the component (B) in the fat or oil composition to the content of α-linolenic acid in the constituent fatty acids of the fat or oil as the component (A), [(B)/(C18:3)], is preferably from 0.0002 to 0.015, more preferably from 0.0005 to 0.01, more preferably from 0.001 to 0.01, even more preferably from 0.0015 to 0.01.
<12> The fat or oil composition according to any one of the above-mentioned items <1> to <11>, in which the content of the component (C1) is 0.00001 mass % or more, more preferably 0.00002 mass % or more, more preferably 0.00004 mass % or more, more preferably 0.0001 mass % or more, even more preferably 0.0002 mass % or more.
<13> The fat or oil composition according to any one of the above-mentioned items <1> to <12>, in which the content of the component (C1) is 0.0025 mass % or less, more preferably 0.002 mass % or less, more preferably 0.0018 mass % or less, more preferably 0.0015 mass % or less, more preferably 0.0012 mass % or less, more preferably 0.0009 mass % or less, even more preferably 0.0007 mass % or less.
<14> The fat or oil composition according to any one of the above-mentioned items <1> to <11>, in which the content of the component (C1) is preferably from 0.00001 to 0.002 mass %, more preferably from 0.00002 to 0.0009 mass %, more preferably from 0.00002 to 0.0018 mass %, more preferably from 0.00002 to 0.0015 mass %, more preferably from 0.00002 to 0.0009 mass %, more preferably from 0.00002 to 0.0007 mass %, more preferably from 0.00004 to 0.0007 mass %, more preferably from 0.0001 to 0.0007 mass %, even more preferably from 0.0002 to 0.0007 mass %.
<15> The fat or oil composition according to any one of the above-mentioned items <1> to <14>, in which the ratio (content mass ratio) of the content of the component (C1) to the content of the component (B), [(C1)/(B)], is preferably 0.0003 or more, more preferably 0.0004 or more, more preferably 0.001 or more, even more preferably 0.002 or more.
<16> The fat or oil composition according to any one of the above-mentioned items <1> to <15>, in which the ratio (content mass ratio) of the content of the component (C1) to the content of the component (B), [(C1)/(B)], is preferably 0.08 or less, more preferably 0.05 or less, more preferably 0.03 or less, more preferably 0.019 or less, more preferably 0.018 or less, even more preferably 0.017 or less.
<17> The fat or oil composition according to any one of the above-mentioned items <1> to <14>, in which the ratio (content mass ratio), [(C1)/(B)], of the content of the component (C1) to the content of the component (B) is preferably from 0.0003 to 0.08, more preferably from 0.0004 to 0.05, more preferably from 0.0004 to 0.03, more preferably from 0.001 to 0.03, more preferably from 0.002 to 0.03, more preferably from 0.002 to 0.019, more preferably from 0.002 to 0.018, even more preferably from 0.002 to 0.017.
<18> A fat or oil composition, comprising the following components (A), (B), and (C2):

(A) a fat or oil in which a content of α-linolenic acid in constituent fatty acids of the fat or oil is from 15 to 60 mass %;

(B) a rosemary extract at a content of from 0.005 to 0.25 mass %; and

(C2) one or two or more selected from the group consisting of a clove extract, an oregano extract, and a bay laurel extract at a content of from 0.00001 to 0.001 mass %.

<19> The fat or oil composition according to the above-mentioned item <18>, in which the content of α-linolenic acid in the constituent fatty acids of the fat or oil as the component (A) is 15 mass % or more, more preferably 17 mass % or more, even more preferably 20 mass % or more.
<20> The fat or oil composition according to the above-mentioned item <18> or <19>, in which the content of α-linolenic acid in the constituent fatty acids of the fat or oil as the component (A) is 60 mass % or less, more preferably 55 mass % or less, more preferably 50 mass % or less, more preferably 45 mass % or less, more preferably 40 mass % or less, more preferably 30 mass % or less, even more preferably 25 mass % or less.
<21> The fat or oil composition according to the above-mentioned item <18>, in which the content of linolenic acid in the constituent fatty acids of the fat or oil as the component (A) is preferably from 15 to 50 mass %, more preferably from 15 to 40 mass %, more preferably from 15 to 30 mass %, even more preferably from 15 to 25 mass %.
<22> The fat or oil composition according to any one of the above-mentioned items <18> to <21>, in which the component (A) preferably includes one or two or more of fats or oils selected from the group consisting of linseed oil, Japanese basil oil, and perilla oil.
<23> The fat or oil composition according to any one of the above-mentioned items <18> to <22>, in which the content of the rosemary extract as the component (B) is 0.01 mass % or more, more preferably 0.02 mass % or more, even more preferably 0.03 mass % or more.
<24> The fat or oil composition according to any one of the above-mentioned items <18> to <23>, in which the content of the rosemary extract as the component (B) is 0.25 mass % or less, more preferably 0.2 mass % or less, more preferably 0.17 mass % or less, more preferably 0.16 mass % or less, even more preferably 0.15 mass % or less.
<25> The fat or oil composition according to any one of the above-mentioned items <18> to <22>, in which the content of the rosemary extract as the component (B) is preferably from 0.01 to 0.25 mass %, more preferably from 0.01 to 0.2 mass %, more preferably from 0.02 to 0.17 mass %, even more preferably from 0.03 to 0.15 mass %.
<26> The fat or oil composition according to any one of the above-mentioned items <18> to <25>, in which the ratio (content mass ratio) of the content of the rosemary extract as the component (B) in the fat or oil composition to the content of α-linolenic acid in the constituent fatty acids of the fat or oil as the component (A), [(B)/(C18:3)], is preferably 0.0002 or more, more preferably 0.0005 or more, more preferably 0.001 or more, even more preferably 0.0015 or more.
<27> The fat or oil composition according to any one of the above-mentioned items <18> to <26>, in which the ratio (content mass ratio) of the content of the rosemary extract as the component (B) in the fat or oil composition to the content of α-linolenic acid in the constituent fatty acids of the fat or oil as the component (A), [(B)/(C18:3)], is preferably 0.015 or less, more preferably 0.01 or less.
<28> The fat or oil composition according to any one of the above-mentioned items <18> to <25>, in which the ratio (content mass ratio) of the content of the rosemary extract as the component (B) in the fat or oil composition to the content of α-linolenic acid in the constituent fatty acids of the fat or oil as the component (A), [(B)/(C18:3)], is preferably from 0.0002 to 0.015, more preferably from 0.0005 to 0.01, more preferably from 0.001 to 0.01, even more preferably from 0.0015 to 0.01.
<29> The fat or oil composition according to any one of the above-mentioned items <18> to <28>, in which the content of the component (C2) is 0.00001 mass % or more, more preferably 0.00002 mass % or more, more preferably 0.00005 mass % or more, even more preferably 0.0001 mass % or more.
<30> The fat or oil composition according to any one of the above-mentioned items <18> to <29>, in which the content of the component (C2) is preferably 0.0009 mass % or less, more preferably 0.0008 mass % or less, even more preferably 0.0005 mass % or less.
<31> The fat or oil composition according to any one of the above-mentioned items <18> to <28>, in which the content of the component (C2) is preferably from 0.00001 to 0.0009 mass %, more preferably from 0.00002 to 0.0009 mass %, more preferably from 0.00002 to 0.0008 mass %, more preferably from 0.00005 to 0.0005 mass %, even more preferably from 0.0001 to 0.0005 mass %.
<32> The fat or oil composition according to any one of the above-mentioned items <18> to <31>, in which the ratio (content mass ratio) of the content of the component (C2) to the content of the component (B), [(C2)/(B)], is preferably 0.0001 or more, more preferably 0.0004 or more, even more preferably 0.001 or more.
<33> The fat or oil composition according to any one of the above-mentioned items <18> to <32>, in which the ratio (content mass ratio) of the content of the component (C2) to the content of the component (B), [(C2)/(B)], is preferably 0.03 or less, more preferably 0.019 or less, more preferably 0.018 or less, even more preferably 0.007 or less.
<34> The fat or oil composition according to any one of the above-mentioned items <18> to <31>, in which the ratio (content mass ratio) of the content of the component (C2) to the content of the component (B), [(C2)/(B)], is preferably from 0.0001 to 0.03, more preferably from 0.0001 to 0.018, even more preferably from 0.001 to 0.007.
<35> The fat or oil composition according to any one of the above-mentioned items <1> to <34>, in which the fat or oil composition comprises preferably 95 to 99.95 mass %, more preferably 97 to 99 mass % of the fat or oil as the component (A).
<36> The fat or oil composition according to any one of the above-mentioned items <1> to <35>, in which the content of triacylglycerols in the fat or oil as the component (A) is preferably from 78 to 100 mass %, more preferably from 88 to 100 mass %, more preferably from 90 to 99.5 mass, even more preferably from 92 to 99 mass %.
<37> The fat or oil composition according to any one of the above-mentioned items <1> to <36>, in which a ratio of unsaturated fatty acids in the constituent fatty acids of the fat or oil as the component (A) other than α-linolenic acid is preferably from 60 to 100 mass %, more preferably from 70 to 100 mass %, more preferably from 75 to 100 mass %, even more preferably from 80 to 98 mass %.
<38> The fat or oil composition according to any one of the above-mentioned items <1> to <37>, further comprising preferably one or two or more of antioxidants selected from the group consisting of a natural antioxidant, a tocopherol, and an ascorbic acid ester, more preferably one or two or more of antioxidants selected from the group consisting of a natural antioxidant, a tocopherol, and ascorbyl palmitate, even more preferably ascorbyl palmitate and a tocopherol as antioxidants.
<39> The fat or oil composition according to the above-mentioned item <38>, in which the content of the antioxidant is preferably from 0.01 to 0.2 mass %, more preferably from 0.02 to 0.1 mass %.
<40> The fat or oil composition according to any one of the above-mentioned items <1> to <39>, in which the rosemary extract as the component (B) is preferably an extract obtained from one or two or more of parts selected from the group consisting of leaf, stem, germ, flower, branch, root, and seed of rosemary.
<41> The fat or oil composition according to any one of the above-mentioned items <1> to <39>, in which the rosemary extract as the component (B) is preferably one extracted with one or two or more of solvents selected from the group consisting of water, steam, an alcohol, subcritical or supercritical carbon dioxide, and an edible fat or oil.
<42> The fat or oil composition according to the above-mentioned item <41>, in which the alcohol is preferably one or two or more selected from the group consisting of methanol and ethanol, and the edible fat or oil is preferably one or two or more selected from the group consisting of soybean oil, rapeseed oil, sunflower oil, palm oil, and lard.
<43> The fat or oil composition according to any one of the above-mentioned items <1> to <42>, in which each of the extracts as the component (C1) and the component (C2) is preferably an extract obtained from one or two or more of parts selected from the group consisting of leaf, stem, germ, flower, branch, root, and seed of thyme, basil, clove, oregano, or bay laurel.
<44> The fat or oil composition according to any one of the above-mentioned items <1> to <43>, in which each of the extracts as the component (C1) and the component (C2) is preferably one extracted with one or two or more of solvents selected from the group consisting of water, steam, an alcohol, subcritical or supercritical carbon dioxide, and an edible fat or oil.
<45> The fat or oil composition according to the above-mentioned item <44>, in which the alcohol is preferably one or two or more selected from the group consisting of methanol and ethanol, and the edible fat or oil is preferably one or two or more selected from the group consisting of soybean oil, rapeseed oil, sunflower oil, palm oil, and lard.
<46> The fat or oil composition according to any one of the above-mentioned items <1> to <45>, in which the rosemary extract as the component (B) is preferably a commercially available product, more preferably one commercially available as an antioxidant, even more preferably one commercially available as an antioxidant for foods and beverages.
<47> The fat or oil composition according to any one of the above-mentioned items <1> to <46>, in which each of the extracts as the component (C1) and the component (C2) is preferably a commercially available product, more preferably one commercially available as a product for foods.
<48> Use of the fat or oil composition according to any one of the above-mentioned items <1> to <47> as an edible fat or oil.
<49> The use according to the above-mentioned item <48> as a fat or oil for cooking.
<50> The use according to the above-mentioned item <48> as a fat or oil for cooking of a deep-fried food, a sauteed food, or a grilled food.
<51> A method of improving oxidative stability of a fat or oil composition, comprising blending a rosemary extract as a component (B) and a thyme extract, a basil extract, or a combination thereof as a component (C1) into a fat or oil composition containing, as a component (A), a fat or oil in which a content of α-linolenic acid in constituent fatty acids of the fat or oil is from 15 to 60 mass %, so that the content of the rosemary extract as the component (B) is from 0.005 to 0.25 mass % and the content of the thyme extract, the basil extract, or the combination thereof as the component (C1) is from 0.00001 to 0.0025 mass %.
<52> The method of improving oxidative stability of a fat or oil composition according to the above-mentioned item <51>, comprising blending the rosemary extract as the component (B) into the fat or oil composition, so that the ratio (content mass ratio) of the content of the rosemary extract as the component (B) in the fat or oil composition to the content of α-linolenic acid in the constituent fatty acids of the fat or oil as the component (A) in the fat or oil composition, [(B)/(C18:3)], is preferably 0.0002 or more, more preferably 0.0005 or more, more preferably 0.001 or more, even more preferably 0.0015 or more, is preferably 0.015 or less, more preferably 0.01 or less, and is preferably from 0.0002 to 0.015, more preferably from 0.0005 to 0.01, more preferably from 0.001 to 0.01, even more preferably from 0.0015 to 0.01.
<53> The method of improving oxidative stability of a fat or oil composition according to the above-mentioned item <51> or <52>, comprising blending the rosemary extract as the component (B) and the thyme extract, the basil extract, or the combination thereof as the component (C1) into the fat or oil composition, so that the ratio (content mass ratio) of the content of the component (C1) in the fat or oil composition to the content of the component (B) in the fat or oil composition, [(C1)/(B)], is preferably 0.0003 or more, more preferably 0.0004 or more, more preferably 0.001 or more, even more preferably 0.002 or more, is preferably 0.08 or less, more preferably 0.05 or less, more preferably 0.03 or less, more preferably 0.019 or less, more preferably 0.018 or less, even more preferably 0.017 or less, and is preferably from 0.0003 to 0.08, more preferably from 0.0004 to 0.05, more preferably from 0.0004 to 0.03, more preferably from 0.001 to 0.03, more preferably from 0.002 to 0.03, more preferably from 0.002 to 0.019, more preferably from 0.002 to 0.018, even more preferably from 0.002 to 0.017.
<54> A method of improving oxidative stability of a fat or oil composition, comprising blending a rosemary extract as a component (B) and one or two or more, as a component (C2), selected from the group consisting of a clove extract, an oregano extract, and a bay laurel extract into a fat or oil composition containing, as a component (A), a fat or oil in which a content of α-linolenic acid in constituent fatty acids of the fat or oil is from 15 to 60 mass %, so that the content of the rosemary extract as the component (B) is from 0.005 to 0.25 mass and the content of the one or two or more, as the component (C2), selected from the clove extract, the oregano extract, and the bay laurel extract is from 0.00001 to 0.001 mass %.
<55> The method of improving oxidative stability of a fat or oil composition according to the above-mentioned item <54>, comprising blending the rosemary extract as the component (B) into the fat or oil composition, so that the ratio (content mass ratio) of the content of the rosemary extract as the component (B) in the fat or oil composition to the content of α-linolenic acid in the constituent fatty acids of the fat or oil as the component (A) in the fat or oil composition, [(B)/(C18:3)], is preferably 0.0002 or more, more preferably 0.0005 or more, more preferably 0.001 or more, even more preferably 0.0015 or more, is preferably 0.015 or less, more preferably 0.01 or less, and is preferably from 0.0002 to 0.015, more preferably from 0.0005 to 0.01, more preferably from 0.001 to 0.01, even more preferably from 0.0015 to 0.01.
<56> The method of improving oxidative stability of a fat or oil composition according to the above-mentioned item <54> or <55>, comprising blending the rosemary extract as the component (B) and the one or two or more, as the component (C2), selected from the group consisting of the clove extract, the oregano extract, and the bay laurel extract into the fat or oil composition, so that the ratio (content mass ratio) of the content of the component (C2) in the fat or oil composition to the content of the component (B) in the fat or oil composition, [(C2)/(B)], is preferably 0.0001 or more, more preferably 0.0004 or more, even more preferably 0.001 or more, is preferably 0.03 or less, more preferably 0.019 or less, more preferably 0.018 or less, even more preferably 0.007 or less, and is preferably from 0.0001 to 0.03, more preferably from 0.0001 to 0.018, even more preferably from 0.001 to 0.007.
<57> A method of suppressing odor of a rosemary extract as a component (B), comprising blending a thyme extract, a basil extract, or a combination thereof as a component (C1) into a fat or oil composition containing the rosemary extract as the component (B) at a content of from 0.005 to 0.25 mass and containing, as a component (A), a fat or oil in which a content of α-linolenic acid in constituent fatty acids of the fat or oil is from 15 to 60 mass %, so that the content of the thyme extract, the basil extract, or the combination thereof as the component (C1) is from 0.00001 to 0.0025 mass %.
<58> The method of suppressing odor of a rosemary extract as a component (B) according to the above-mentioned item <57>, comprising blending the thyme extract, the basil extract, or the combination thereof as the component (C1) into the fat or oil composition, so that the ratio (content mass ratio) of the content of the component (C1) in the fat or oil composition to the content of the component (B) in the fat or oil composition, [(C1)/(B)], is preferably 0.0003 or more, more preferably 0.0004 or more, more preferably 0.001 or more, even more preferably 0.002 or more, is preferably 0.08 or less, more preferably 0.05 or less, more preferably 0.03 or less, more preferably 0.019 or less, more preferably 0.018 or less, even more preferably 0.017 or less, and is preferably from 0.0003 to 0.08, more preferably from 0.0004 to 0.05, more preferably from 0.0004 to 0.03, more preferably from 0.001 to 0.03, more preferably from 0.002 to 0.03, more preferably from 0.002 to 0.019, more preferably from 0.002 to 0.018, even more preferably from 0.002 to 0.017.
<59> A method of suppressing odor of a rosemary extract as a component (B), comprising blending one or two or more, as a component (C2), selected from the group consisting of a clove extract, an oregano extract, and a bay laurel extract into a fat or oil composition containing the rosemary extract as the component (B) at a content of from 0.005 to 0.25 mass % and containing, as a component (A), a fat or oil in which a content of α-linolenic acid in constituent fatty acids of the fat or oil is from 15 to 60 mass %, so that the content of the one or two or more, as the component (C2), selected from the group consisting of the clove extract, the oregano extract, and the bay laurel extract is from 0.00001 to 0.001 mass %.
<60> The method of suppressing odor of a rosemary extract as a component (B) according to the above-mentioned item <59>, comprising blending the one or two or more, as the component (C2), selected from the group consisting of the clove extract, the oregano extract, and the bay laurel extract into the fat or oil composition, so that the ratio (content mass ratio) of the content of the component (C2) in the fat or oil composition to the content of the component (B) in the fat or oil composition, [(C2)/(B)], is preferably 0.0001 or more, more preferably 0.0004 or more, even more preferably 0.001 or more, is preferably 0.03 or less, more preferably 0.019 or less, more preferably 0.018 or less, even more preferably 0.007 or less, and is preferably from 0.0001 to 0.03, more preferably from 0.0001 to 0.018, more preferably from 0.001 to 0.007.

### EXAMPLES

### Analysis Methods

### (1) Composition of Glycerides in Fat or Oil

About 10 mg of a fat or oil sample and 0.5 mL of a trimethylsilylating agent (“Silylating agent TH,” manufactured by Kanto Chemical Co., Inc.) were placed in a glass sample bottle, and the bottle was sealed and heated at 70° C. for 15 minutes. 1.0 mL of water and 1.5 mL of hexane were added thereto, and the bottle was shaken. The bottle was allowed to stand still, and then the upper layer was analyzed by gas-liquid chromatography (GLC).

### <GLC Analysis Conditions>

### (Conditions)

Apparatus: Agilent 6890 Series (manufactured by Agilent Technologies)
Integrator: ChemStation B.02.01 SR2 (manufactured by Agilent Technologies)
Column: DB-1ht (manufactured by Agilent J&W)

### Carrier gas: 1.0 mL He/min

### Injector: Split (1:50), T=320° C.

### Detector: FID, T=350° C.

Oven temperature: The temperature was raised from 80° C. to 340° C. at 10° C./min, and kept for 15 minutes.

### (2) Composition of Constituent Fatty Acids in Fat or Oil

Fatty acid methyl esters were prepared in accordance with “Preparation method for fatty acid methyl ester (2.4.1.-1996)” described in “Standard Methods for the Analysis of Fats, Oils and Related Materials” edited by Japan Oil Chemists' Society, and the resultant fat or oil samples were subjected to measurement in accordance with American Oil Chemists. Society Official Method Ce if-96 (GLC method).

### <GLC Analysis Conditions>

Column: CP-SIL88 100 m×0.25 mm×0.2 μm (VARIAN)

### Carrier gas: 1.0 mL He/min

### Injector: Split (1:200), T=250° C.

### Detector: FID, 1=250° C.

Oven temperature: The temperature was kept at 174° C. for 50 minutes, raised to 220° C. at 5° C./min, and kept for 25 minutes.

(Raw Materials)

Fats or oils having the compositions shown in Table 1 (fat or oil a: refined linseed oil (manufactured by Summit Oil Mill Co., Ltd.) and a fat or oil b: rapeseed salad oil (manufactured by The Nisshin OilliO Group, Ltd.)) were used as the fats or oils a and b as the component (A).

Preparations (RME-1 and RME-2, and SE-1 to SE-4) shown in Table 2 were used as the rosemary extract as the component (B), the thyme extract as the component (C1), and the basil extract as the component (C1).

Preparations (OE-1 to OE-5) shown in Table 3 were used as the clove extract, the oregano extract, and the bay laurel extract as the component (C2).

TABLE 1

| | | | | | | | | | | | Glyceride composition | | | |
|---|---|---|---|---|---|---|---|---|---|---|---|---|---|---|
| | Fatty acid composition (mass %) | | | | | | | | | | (mass %) | | | |
| | C16:0 | C16:1 | C18:0 | C18:1 | C18:2 | C18:3 | C20:0 | C20:1 | C22:0 | C22:1 | FFA | MAG | DAG | TAG |
| Fat or | 5.06 | 0.06 | 3.31 | 19.52 | 15.96 | 54.63 | 0.13 | 0.78 | 0.12 | 0.07 | 0.03 | 0.00 | 2.63 | 97.35 |
| oil a | | | | | | | | | | | | | | |
| Fat or | 4.05 | 0.21 | 1.75 | 61.50 | 19.79 | 10.18 | 0.60 | 1.15 | 0.23 | 0.05 | 0.03 | 0.00 | 1.58 | 98.40 |
| oil b | | | | | | | | | | | | | | |

MAG: Monoacylglycerol
DAG: Diacylglycerol
TAG: Triacylglycerol
FFA: Free fatty acid

TABLE 2

| | | | | Content of |
|---|---|---|---|---|
| | Abbre- | | | extract in |
| | viated | | | preparation |
| | name | Company name | Name | [mass %] |
| Rosemary | RME-1 | KALSEC | Herbalox HT-O | 40 |
| extract | RME-2 | Mitsubishi-Kagaku | RM Keeper OS | 20 |
| | | Foods Corporation | | |
| Thyme | SE-1 | Ogawa & Co., Ltd. | Spice OG | 10 |
| extract | | | Thyme | |
| | SE-2 | T. HASEGAWA | Thyme Flavor | 5 |
| | | CO., LTD. | FH-3910 | |
| Basil | SE-3 | Ogawa & Co., Ltd. | Spice OG Basil | 10 |
| extract | SE-4 | T. HASEGAWA | Basil Flavor | 1 |
| | | CO., LTD. | FH-4346 | |

TABLE 3

| | | | | Content of |
|---|---|---|---|---|
| | Abbre- | | | extract in |
| | viated | | | preparation |
| | name | Company name | Name | [mass %] |
| Clove | OE-1 | Ogawa & Co., Ltd. | Spice OG | 10 |
| extract | | | Clove | |
| | OE-2 | T. HASEGAWA | Clove Flavor | 5 |
| | | CO., LTD. | FH-4345 | |
| Oregano | OE-3 | T. HASEGAWA | Oregano Flavor | 5 |
| extract | | CO., LTD. | FH-3909 | |
| Bay | OE-4 | Ogawa & Co., Ltd. | Spice OG | 10 |
| laurel | | | Laurel | |
| extract | OE-5 | T. HASEGAWA | Laurel Flavor | 3 |
| | | CO., LTD. | FH-3912 | |

### Examples 1 to 11 and Comparative Examples 1 to 5

### Preparation of Fat or oil Compositions

The fat or oil a, the fat or oil b, the rosemary extract (RME-1), the thyme extract (SE-1), the basil extract (SE-3), and mixed tocopherols (manufactured by Archer Daniels Midland) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, the contents of the thyme extract, the contents of the basil extract, and the contents of the mixed tocopherols in the fat or oil compositions are as shown in Table 4. It should be noted that the blending amounts of the rosemary extract, the thyme extract, and the basil extract in the preparations were determined from the contents of the extracts in the preparations shown in Table 2 so as to achieve the contents shown in Table 4.

(Evaluation of Oxidative Stability)

The fat or oil compositions shown in Table 4 were used to evaluate oxidative stability. The oxidative stability was evaluated in accordance with “CDM test (2.5.1.2-1996)” described in “Standard Methods for the Analysis of Fats, Oils and Related Materials” edited by Japan Oil Chemists' Society by calculating induction time (hr), and the results were each represented as an oxidative stability index (OSI). The results are shown in Table 4.

(Thin Film Heating Test)

The fat or oil compositions shown in Table 4 were subjected to a thin film heating test. In the thin film heating test, 3 g of each of the fat or oil compositions was added to a stainless-steel petri dish with a diameter of 6 cm and placed on a hot plate heated to 150° C., and 10 minutes later, “degradation odor due to oxidation” was evaluated. Nine panelists evaluated their “degradation odor due to oxidation” in accordance with the following criteria, and mean values thereof were determined as scores. The results are shown in Table 4.

### (Degradation Odor Due to Oxidation)

5: Not sensed
4: Hardly not sensed
3: Slightly sensed

### 2: Sensed

1: Strongly sensed

TABLE 4

| | | Example | | | | | | | |
|---|---|---|---|---|---|---|---|---|---|
| | | 1 | 2 | 3 | 4 | 5 | 6 | 7 | 8 |
| Fat or oil a | | 24.7 | 24.7 | 24.7 | 24.7 | 24.7 | 24.7 | 13.4 | 13.4 |
| Fat or oil b | | 75.3 | 75.3 | 75.3 | 75.3 | 75.3 | 75.3 | 86.6 | 86.6 |
| (A) Ratio in | [mass | | | | | | | | |
| fat or oil | %] | | | | | | | | |
| C18:3 | | 20 | 20 | 20 | 20 | 20 | 20 | 15 | 15 |
| (B) RME-1 | [mass | 100 | 300 | 500 | 800 | 1,000 | 2,000 | 100 | 250 |
| | ppm] | | | | | | | | |
| (C1) SE-1 | [mass | 1 | 0 | 5 | 0 | 10 | 0 | 1 | 0 |
| | ppm] | | | | | | | | |
| (C1) SE-3 | [mass | 0 | 3 | 0 | 8 | 0 | 20 | 0 | 2.5 |
| | ppm] | | | | | | | | |
| (B)/(C18:3) | [mass | 0.0005 | 0.0015 | 0.0025 | 0.0040 | 0.0050 | 0.0100 | 0.0007 | 0.0017 |
| | ratio] | | | | | | | | |
| (C1)/(B) | [mass | 0.0100 | 0.0100 | 0.0100 | 0.0100 | 0.0100 | 0.0100 | 0.0100 | 0.0100 |
| | ratio] | | | | | | | | |
| Mixed | [mass | — | — | — | — | — | — | — | — |
| tocopherols | ppm] | | | | | | | | |

| | | | | | | | | |
|---|---|---|---|---|---|---|---|---|
| OSI | 3 | 3.4 | 4.1 | 4.5 | 4.7 | 6 | 3.5 | 4.3 |
| Degradation odor | 4 | 5 | 5 | 5 | 5 | 5 | 5 | 5 |
| due to oxidation | | | | | | | | |

| | | Example | | | Comparative Example | | | | |
|---|---|---|---|---|---|---|---|---|---|
| | | 9 | 10 | 11 | 1 | 2 | 3 | 4 | 5 |
| Fat or oil a | | 13.4 | 47.2 | 69.8 | 13.4 | 24.7 | 47.2 | 69.8 | 24.7 |
| Fat or oil b | | 86.6 | 52.8 | 30.2 | 86.6 | 75.3 | 52.8 | 30.2 | 75.3 |
| (A) Ratio in | [mass | | | | | | | | |
| fat or oil | %] | | | | | | | | |
| C18:3 | | 15 | 30 | 40 | 15 | 20 | 30 | 40 | 20 |
| (B) RME-1 | [mass | 500 | 1,000 | 1,000 | 10 | 10 | 10 | 10 | 10 |
| | ppm] | | | | | | | | |
| (C1) SE-1 | [mass | 5 | 0 | 10 | 0 | 0 | 0 | 0 | 0 |
| | ppm] | | | | | | | | |
| (C1) SE-3 | [mass | 0 | 10 | 0 | 0 | 0 | 0 | 0 | 0 |
| | ppm] | | | | | | | | |
| (B)/(C18:3) | [mass | 0.0033 | 0.0033 | 0.0025 | — | — | — | — | — |
| | ratio] | | | | | | | | |
| (C1)/(B) | [mass | 0.0100 | 0.0100 | 0.0100 | — | — | — | — | — |
| | ratio] | | | | | | | | |
| Mixed | [mass | — | — | — | — | — | — | — | 1,000 |
| tocopherols | ppm] | | | | | | | | |

| | | | | | | | | |
|---|---|---|---|---|---|---|---|---|
| OSI | 4.9 | 3.8 | 3.5 | 3.1 | 2.6 | 1.8 | 1.4 | 3.0 |
| Degradation odor | 5 | 5 | 5 | 3 | 2 | 1 | 1 | 3 |
| due to oxidation | | | | | | | | |

As is apparent from the results shown in Table 4, it was confirmed that the fat or oil compositions of the present invention have high oxidative stability and have suppressed degradation odor at the time of heating as well.

### Examples 12 to 39 and Comparative Examples 6 to 9

### Preparation of Fat or oil Compositions

The fat or oil a, the fat or oil b, the rosemary extract (RME-1), and the thyme extract (SE-1) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, and the contents of the thyme extract in the fat or oil compositions are as shown in Table 5. It should be noted that the blending amounts of the rosemary extract and the thyme extract in the preparations were determined from the contents of the extracts in the preparations shown in Table 2 so as to achieve the contents shown in Table 5.

### Examples 40 to 67 and Comparative Examples 10 to 13

### Preparation of Fat or oil Compositions

The fat or oil a, the fat or oil b, the rosemary extract (RME-1), and the basil extract (SE-3) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, and the contents of the basil extract in the fat or oil compositions are as shown in Table 6. It should be noted that the blending amounts of the rosemary extract and the basil extract in the preparations were determined from the contents of the extracts in the preparations shown in Table 2 so as to achieve the contents shown in Table 6.

(Thin Film Heating Test)

The fat or oil compositions shown in Tables 5 and 6 were subjected to the thin film heating test in the same manner as above to evaluate the “degradation odor due to oxidation”. In addition, nine panelists evaluated their “odor derived from rosemary extract” and “odor derived from thyme extract” or “odor derived from basil extract” (referred to as “odor derived from plant extract”) by the thin film heating test in the same manner as above in accordance with the following criteria, and mean values thereof were determined as scores. The results are shown in Tables 5 and 6.

(Odor Derived from Rosemary Extract)
5: Not sensed
4: Hardly not sensed
3: Slightly sensed

### 2: Sensed

1: Strongly sensed
(Odor Derived from Plant Extract)
5: Not sensed
4: Hardly not sensed
3: Slightly sensed

### 2: Sensed

1: Strongly sensed

TABLE 5

| | | Example | | | | | | | | | |
|---|---|---|---|---|---|---|---|---|---|---|---|
| | | 12 | 13 | 14 | 15 | 16 | 17 | 18 | 19 | 20 | 21 |
| Fat or oil a | | 24.7 | 24.7 | 24.7 | 24.7 | 24.7 | 24.7 | 24.7 | 24.7 | 24.7 | 24.7 |
| Fat or oil b | | 75.3 | 75.3 | 75.3 | 75.3 | 75.3 | 75.3 | 75.3 | 75.3 | 75.3 | 75.3 |
| (A) Ratio in | [mass | | | | | | | | | | |
| fat or oil | %] | | | | | | | | | | |
| C18:3 | | 20 | 20 | 20 | 20 | 20 | 20 | 20 | 20 | 20 | 20 |
| (B) RME-1 | [mass | 100 | 300 | 300 | 300 | 300 | 300 | 500 | 500 | 500 | 500 |
| | ppm] | | | | | | | | | | |
| (C1) SE-1 | [mass | 5 | 1 | 3 | 5 | 9 | 15 | 0.2 | 1 | 3 | 5 |
| | ppm] | | | | | | | | | | |
| (B)/(C18:3) | [mass | 0.0005 | 0.0015 | 0.0015 | 0.0015 | 0.0015 | 0.0015 | 0.0025 | 0.0025 | 0.0025 | 0.0025 |
| | ratio] | | | | | | | | | | |
| (C1)/(B) | [mass | 0.0500 | 0.0033 | 0.0100 | 0.0167 | 0.0300 | 0.0500 | 0.0004 | 0.0020 | 0.0060 | 0.0100 |
| | %] | | | | | | | | | | |
| Odor derived from | | 5 | 5 | 5 | 5 | 5 | 5 | 4 | 5 | 5 | 5 |
| rosemary extract | | | | | | | | | | | |
| Odor derived from | | 4 | 5 | 5 | 5 | 5 | 3 | 5 | 5 | 5 | 5 |
| plant extract | | | | | | | | | | | |
| Degradation odor | | 4 | 5 | 5 | 5 | 5 | 5 | 5 | 5 | 5 | 5 |
| due to oxidation | | | | | | | | | | | |

| | | Example | | | | | | | | |
|---|---|---|---|---|---|---|---|---|---|---|
| | | 22 | 23 | 24 | 25 | 26 | 27 | 28 | 29 | 30 |
| Fat or oil a | | 24.7 | 24.7 | 24.7 | 24.7 | 24.7 | 24.7 | 24.7 | 24.7 | 24.7 |
| Fat or oil b | | 75.3 | 75.3 | 75.3 | 75.3 | 75.3 | 75.3 | 75.3 | 75.3 | 75.3 |
| (A) Ratio in | [mass | | | | | | | | | |
| fat or oil | %] | | | | | | | | | |
| C18:3 | | 20 | 20 | 20 | 20 | 20 | 20 | 20 | 20 | 20 |
| (B) RME-1 | [mass | 500 | 500 | 500 | 500 | 800 | 800 | 800 | 800 | 800 |
| | ppm] | | | | | | | | | |
| (C1) SE-1 | [mass | 7 | 9 | 15 | 20 | 1 | 3 | 5 | 9 | 15 |
| | ppm] | | | | | | | | | |
| (B)/(C18:3) | [mass | 0.0025 | 0.0025 | 0.0025 | 0.0025 | 0.004 | 0.004 | 0.004 | 0.004 | 0.004 |
| | ratio] | | | | | | | | | |
| (C1)/(B) | [mass | 0.0140 | 0.0180 | 0.0300 | 0.0400 | 0.0013 | 0.0038 | 0.0063 | 0.0113 | 0.0188 |
| | %] | | | | | | | | | |
| Odor derived from | | 5 | 5 | 5 | 5 | 5 | 5 | 5 | 5 | 5 |
| rosemary extract | | | | | | | | | | |
| Odor derived from | | 5 | 5 | 4 | 3 | 5 | 5 | 5 | 5 | 4 |
| plant extract | | | | | | | | | | |
| Degradation odor | | 5 | 5 | 5 | 5 | 5 | 5 | 5 | 5 | 5 |
| due to oxidation | | | | | | | | | | |

| | | Example | | | | | | |
|---|---|---|---|---|---|---|---|---|
| | | 31 | 32 | 33 | 34 | 35 | 36 | 37 |
| Fat or oil a | | 24.7 | 24.7 | 24.7 | 24.7 | 24.7 | 24.7 | 24.7 |
| Fat or oil b | | 75.3 | 75.3 | 75.3 | 75.3 | 75.3 | 75.3 | 75.3 |
| (A) Ratio in | [mass | | | | | | | |
| fat or oil | %] | | | | | | | |
| C18:3 | | 20 | 20 | 20 | 20 | 20 | 20 | 20 |
| (B) RME-1 | [mass | 1,000 | 1,000 | 1,000 | 1,000 | 1,500 | 1,500 | 1,500 |
| | ppm] | | | | | | | |
| (C1) SE-1 | [mass | 1 | 3 | 5 | 9 | 1 | 5 | 9 |
| | ppm] | | | | | | | |
| (B)/(C18:3) | [mass | 0.005 | 0.005 | 0.005 | 0.005 | 0.0075 | 0.0075 | 0.0075 |
| | ratio] | | | | | | | |
| (C1)/(B) | [mass | 0.0010 | 0.0030 | 0.0050 | 0.0090 | 0.0007 | 0.0033 | 0.0060 |
| | %] | | | | | | | |
| Odor derived from | | 4 | 5 | 5 | 5 | 4 | 5 | 5 |
| rosemary extract | | | | | | | | |
| Odor derived from | | 5 | 5 | 5 | 5 | 5 | 5 | 5 |
| plant extract | | | | | | | | |
| Degradation odor | | 5 | 5 | 5 | 5 | 5 | 5 | 5 |
| due to oxidation | | | | | | | | |

| | | ≃Example | | Comparative Example | | | |
|---|---|---|---|---|---|---|---|
| | | 38 | 39 | 6 | 7 | 8 | 9 |
| Fat or oil a | | 24.7 | 24.7 | 24.7 | 24.7 | 24.7 | 24.7 |
| Fat or oil b | | 75.3 | 75.3 | 75.3 | 75.3 | 75.3 | 75.3 |
| (A) Ratio in | [mass | | | | | | |
| fat or oil | %] | | | | | | |
| C18:3 | | 20 | 20 | 20 | 20 | 20 | 20 |
| (B) RME-1 | [mass | 2,000 | 2,000 | 0 | 500 | 500 | 3,000 |
| | ppm] | | | | | | |
| (C1) SE-1 | [mass | 1 | 5 | 5 | 0.01 | 40 | 5 |
| | ppm] | | | | | | |
| (B)/(C18:3) | [mass | 0.01 | 0.01 | — | 0.0025 | 0.0025 | 0.015 |
| | ratio] | | | | | | |
| (C1)/(B) | [mass | 0.0005 | 0.0025 | — | 0.00002 | 0.0800 | 0.0017 |
| | %] | | | | | | |
| Odor derived from | | 4 | 5 | 5 | 2 | 5 | 2 |
| rosemary extract | | | | | | | |
| Odor derived from | | 5 | 5 | 3 | 5 | 1 | 5 |
| plant extract | | | | | | | |
| Degradation odor | | 5 | 5 | 2 | 5 | 5 | 5 |
| due to oxidation | | | | | | | |

TABLE 6

| | | Example | | | | | | | | | |
|---|---|---|---|---|---|---|---|---|---|---|---|
| | | 40 | 41 | 42 | 43 | 44 | 45 | 46 | 47 | 48 | 49 |
| Fat or oil a | | 24.7 | 24.7 | 24.7 | 24.7 | 24.7 | 24.7 | 24.7 | 24.7 | 24.7 | 24.7 |
| Fat or oil b | | 75.3 | 75.3 | 75.3 | 75.3 | 75.3 | 75.3 | 75.3 | 75.3 | 75.3 | 75.3 |
| (A) Ratio in | [mass | | | | | | | | | | |
| fat or oil | %] | | | | | | | | | | |
| C18:3 | | 20 | 20 | 20 | 20 | 20 | 20 | 20 | 20 | 20 | 20 |
| (B) RME-1 | [mass | 100 | 300 | 300 | 300 | 300 | 300 | 500 | 500 | 500 | 500 |
| | ppm] | | | | | | | | | | |
| (C1) SE-3 | [mass | 5 | 1 | 3 | 5 | 9 | 15 | 0.2 | 1 | 3 | 5 |
| | ppm] | | | | | | | | | | |
| (B)/(C18:3) | [mass | 0.0005 | 0.0015 | 0.0015 | 0.0015 | 0.0015 | 0.0015 | 0.0025 | 0.0025 | 0.0025 | 0.0025 |
| | ratio] | | | | | | | | | | |
| (C1)/(B) | [mass | 0.0500 | 0.0033 | 0.0100 | 0.0167 | 0.0300 | 0.0500 | 0.0004 | 0.0020 | 0.0060 | 0.0100 |
| | ratio] | | | | | | | | | | |

| | | | | | | | | | | |
|---|---|---|---|---|---|---|---|---|---|---|
| Odor derived from | 5 | 5 | 5 | 5 | 5 | 5 | 4 | 5 | 5 | 5 |
| rosemary extract | | | | | | | | | | |
| Odor derived from | 5 | 5 | 5 | 5 | 4 | 3 | 5 | 5 | 5 | 5 |
| plant extract | | | | | | | | | | |
| Degradation odor | 4 | 5 | 5 | 5 | 5 | 5 | 5 | 5 | 5 | 5 |
| due to oxidation | | | | | | | | | | |

| | | Example | | | | | | | | |
|---|---|---|---|---|---|---|---|---|---|---|
| | | 50 | 51 | 52 | 53 | 54 | 55 | 56 | 57 | 58 |
| Fat or oil a | | 24.7 | 24.7 | 24.7 | 24.7 | 24.7 | 24.7 | 24.7 | 24.7 | 24.7 |
| Fat or oil b | | 75.3 | 75.3 | 75.3 | 75.3 | 75.3 | 75.3 | 75.3 | 75.3 | 75.3 |
| (A) Ratio in | [mass | | | | | | | | | |
| fat or oil | %] | | | | | | | | | |
| C18:3 | | 20 | 20 | 20 | 20 | 20 | 20 | 20 | 20 | 20 |
| (B) RME-1 | [mass | 500 | 500 | 500 | 500 | 800 | 800 | 800 | 800 | 800 |
| | ppm] | | | | | | | | | |
| (C1) SE-3 | [mass | 7 | 9 | 15 | 20 | 1 | 3 | 5 | 9 | 15 |
| | ppm] | | | | | | | | | |
| (B)/(C18:3) | [mass | 0.0025 | 0.0025 | 0.0025 | 0.0025 | 0.004 | 0.004 | 0.004 | 0.004 | 0.004 |
| | ratio] | | | | | | | | | |
| (C1)/(B) | [mass | 0.0140 | 0.0180 | 0.0300 | 0.0400 | 0.0013 | 0.0038 | 0.0063 | 0.0113 | 0.0188 |
| | ratio] | | | | | | | | | |

| | | | | | | | | | |
|---|---|---|---|---|---|---|---|---|---|
| Odor derived from | 5 | 5 | 5 | 5 | 4 | 5 | 5 | 5 | 5 |
| rosemary extract | | | | | | | | | |
| Odor derived from | 6 | 4 | 4 | 3 | 5 | 5 | 5 | 4 | 4 |
| plant extract | | | | | | | | | |
| Degradation odor | 5 | 5 | 5 | 5 | 5 | 5 | 5 | 5 | 5 |
| due to oxidation | | | | | | | | | |

| | | Example | | | | | | |
|---|---|---|---|---|---|---|---|---|
| | | 95 | 60 | 61 | 62 | 63 | 64 | 65 |
| Fat or oil a | | 24.7 | 24.7 | 24.7 | 24.7 | 24.7 | 24.7 | 24.7 |
| Fat or oil b | | 75.3 | 75.3 | 75.3 | 75.3 | 75.3 | 75.3 | 75.3 |
| (A) Ratio in | [mass | | | | | | | |
| fat or oil | %] | | | | | | | |
| C18:3 | | 20 | 20 | 20 | 20 | 20 | 20 | 20 |
| (B) RME-1 | [mass | 1,000 | 1,000 | 1,000 | 1,000 | 1,500 | 1,500 | 1,500 |
| | ppm] | | | | | | | |
| (C1) SE-3 | [mass | 1 | 3 | 5 | 9 | 1 | 5 | 9 |
| | ppm] | | | | | | | |
| (B)/(C18:3) | [mass | 0.005 | 0.005 | 0.005 | 0.005 | 0.0075 | 0.0075 | 0.0075 |
| | ratio] | | | | | | | |
| (C1)/(B) | [mass | 0.0010 | 0.0030 | 0.0050 | 0.0090 | 0.0007 | 0.0033 | 0.0060 |
| | ratio] | | | | | | | |

| | | | | | | | |
|---|---|---|---|---|---|---|---|
| Odor derived from | 4 | 5 | 5 | 5 | 4 | 5 | 5 |
| rosemary extract | | | | | | | |
| Odor derived from | 5 | 5 | 5 | 4 | 5 | 5 | 4 |
| plant extract | | | | | | | |
| Degradation odor | 5 | 5 | 5 | 5 | 5 | 5 | 5 |
| due to oxidation | | | | | | | |

| | | Example | | Comparative Example | | | |
|---|---|---|---|---|---|---|---|
| | | 66 | 67 | 10 | 11 | 12 | 13 |
| Fat or oil a | | 24.7 | 24.7 | 24.7 | 24.7 | 24.7 | 24.7 |
| Fat or oil b | | 75.3 | 75.3 | 75.3 | 75.3 | 75.3 | 75.3 |
| (A) Ratio in | [mass | | | | | | |
| fat or oil | %] | | | | | | |
| C18:3 | | 20 | 20 | 20 | 20 | 20 | 20 |
| (B) RME-1 | [mass | 2,000 | 2,000 | 0 | 500 | 500 | 3,000 |
| | ppm] | | | | | | |
| (C1) SE-3 | [mass | 1 | 5 | 5 | 0.01 | 40 | 5 |
| | ppm] | | | | | | |
| (B)/(C18:3) | [mass | 0.01 | 0.01 | — | 0.0025 | 0.0025 | 0.015 |
| | ratio] | | | | | | |
| (C1)/(B) | [mass | 0.0005 | 0.0025 | — | 0.00002 | 0.0800 | 0.0017 |
| | ratio] | | | | | | |

| | | | | | | |
|---|---|---|---|---|---|---|
| Odor derived from | 4 | 4 | 5 | 2 | 5 | 2 |
| rosemary extract | | | | | | |
| Odor derived from | 5 | 5 | 3 | 5 | 1 | 5 |
| plant extract | | | | | | |
| Degradation odor | 5 | 5 | 2 | 5 | 5 | 5 |
| due to oxidation | | | | | | |

As is apparent from the results shown in Tables 5 and 6, it was confirmed that the fat or oil compositions of the present invention have less unpleasant odor peculiar to the rosemary extract and had suppressed degradation odor due to oxidation of the fat or oil at the time of heating. In addition, the odor derived from the thyme extract or the basil extract was also hardly sensed.

### Examples 68 to 73 and Comparative Examples 14 and 15

### Preparation of Fat or oil Compositions

The fat or oil a, the fat or oil b, the rosemary extract (RME-1), the thyme extract (SE-1), and the basil extract (SE-3) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, the contents of the thyme extract, and the contents of the basil extract in the fat or oil compositions are as shown in Table 7. It should be noted that the blending amounts of the rosemary extract, the thyme extract, and the basil extract in the preparations were determined from the contents of the extracts in the preparations shown in Table 2 so as to achieve the contents shown in Table 7.

(Thin Film Heating Test)

The fat or oil compositions shown in Table 7 were subjected to the thin film heating test in the same manner as above to evaluate the “degradation odor due to oxidation”. In addition, nine panelists evaluated their “odor derived from rosemary extract” and “odor derived from thyme extract” or “odor derived from basil extract” (referred to as “odor derived from plant extract”) by the thin film heating test in the same manner as above in accordance with the above-mentioned criteria, and mean values thereof were determined as scores. The results are shown in Table 7.

TABLE 7

| | | | | | | | | Comparative | |
|---|---|---|---|---|---|---|---|---|---|
| | | Example | | | | | | Example | |
| | | 68 | 69 | 70 | 71 | 72 | 73 | 14 | 15 |
| Fat or oil a | | 47.2 | 47.2 | 47.2 | 69.8 | 69.8 | 69.8 | 47.2 | 69.8 |
| Fat or oil b | | 52.8 | 52.8 | 52.8 | 30.2 | 30.2 | 30.2 | 52.8 | 30.2 |
| (A) Ratio in | [mass | | | | | | | | |
| fat or oil | %] | | | | | | | | |
| C18:3 | | 30 | 30 | 30 | 40 | 40 | 40 | 30 | 40 |
| (B) RME-1 | [mass | 500 | 1,000 | 2,000 | 500 | 1,000 | 2,000 | 10 | 10 |
| | ppm] | | | | | | | | |
| (C1) SE-1 | [mass | 5 | 0 | 5 | 0 | 5 | 0 | 5 | 0 |
| | ppm] | | | | | | | | |
| (C1) SE-3 | [mass | 0 | 5 | 0 | 5 | 0 | 5 | 0 | 5 |
| | ppm] | | | | | | | | |
| (B)/(C18:3) | [mass | 0.0017 | 0.0033 | 0.0067 | 0.0013 | 0.0025 | 0.0050 | 0.00003 | 0.00003 |
| | ratio] | | | | | | | | |
| (C1)/(B) | [mass | 0.0100 | 0.0050 | 0.0025 | 0.0100 | 0.0050 | 0.0025 | 0.5000 | 0.5000 |
| | ratio] | | | | | | | | |

| | | | | | | | | |
|---|---|---|---|---|---|---|---|---|
| Odor derived from | 5 | 5 | 5 | 5 | 5 | 5 | 5 | 5 |
| rosemary extract | | | | | | | | |
| Odor derived from | 5 | 5 | 5 | 5 | 5 | 5 | 4 | 4 |
| plant extract | | | | | | | | |
| Degradation odor | 4 | 5 | 5 | 4 | 4 | 5 | 2 | 2 |
| due to oxidation | | | | | | | | |

As is apparent from the results shown in Table 7, it was confirmed that the fat or oil compositions of the present invention have less unpleasant odor peculiar to the rosemary extract and had suppressed degradation odor due to oxidation of the fat or oil at the time of heating. In addition, the odor derived from the thyme extract or the basil extract was also hardly sensed.

### Examples 74 to 89

### Preparation of Fat or oil Compositions

The fat or oil a, the fat or oil b, the rosemary extract (RME-1 or RME-2), the thyme extract (SE-1 or SE-2), and the basil extract (SE-3 or SE-4) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, the contents of the thyme extract and the contents of the basil extract in the fat or oil compositions are as shown in Table 8 or 9. It should be noted that the blending amounts of the rosemary extract, the thyme extract, and the basil extract in the preparations were determined from the contents of the extracts in the preparations shown in Table 2 so as to achieve the contents shown in Table 8 or 9.

(Thin Film Heating Test)

The fat or oil compositions shown in Table 8 or 9 were subjected to the thin film heating test in the same manner as above to evaluate the “degradation odor due to oxidation”. In addition, nine panelists evaluated their “odor derived from rosemary extract” and “odor derived from thyme extract” or “odor derived from basil extract” (referred to as “odor derived from plant extract”) by the thin film heating test in the same manner as above in accordance with the above-mentioned criteria, and mean values thereof were determined as scores. The results are shown in Table 8 or 9.

TABLE 8

| | | Example | | | | | |
|---|---|---|---|---|---|---|---|
| | | 74 | 75 | 76 | 77 | 78 | 79 |
| Fat or oil a | | 4.8 | 4.8 | 4.8 | 4.8 | 4.8 | 4.8 |
| Fat or oil b | | 95.2 | 95.2 | 95.2 | 95.2 | 95.2 | 95.2 |
| (A) Ratio in | [mass | | | | | | |
| fat or oil | %] | | | | | | |
| C18:3 | | 20 | 20 | 20 | 20 | 20 | 20 |
| (B) RME-2 | [mass | 500 | 500 | 500 | 500 | 500 | 500 |
| | ppm] | | | | | | |
| (C1) SE-1 | [mass | 1 | 5 | 9 | 0 | 0 | 0 |
| | ppm] | | | | | | |
| (C1) SE-3 | [mass | 0 | 0 | 0 | 1 | 5 | 9 |
| | ppm] | | | | | | |
| (B)/(C18:3) | [mass | 0.0025 | 0.0025 | 0.0025 | 0.0025 | 0.0025 | 0.0025 |
| | ratio] | | | | | | |
| (C1)/(B) | [mass | 0.0020 | 0.0100 | 0.0180 | 0.0020 | 0.0100 | 0.0180 |
| | ratio] | | | | | | |

| | | | | | | |
|---|---|---|---|---|---|---|
| Odor derived from | 5 | 5 | 5 | 5 | 5 | 5 |
| rosemary extract | | | | | | |
| Odor derived from | 5 | 5 | 4 | 5 | 5 | 4 |
| plant extract | | | | | | |
| Degradation odor | 5 | 5 | 5 | 5 | 5 | 5 |
| due to oxidation | | | | | | |

TABLE 9

| | | Example | | | | | | | | | |
|---|---|---|---|---|---|---|---|---|---|---|---|
| | | 80 | 81 | 82 | 83 | 84 | 85 | 86 | 87 | 88 | 89 |
| Fat or oil a | | 4.8 | 4.8 | 4.8 | 4.8 | 4.8 | 4.8 | 4.8 | 4.8 | 4.8 | 4.8 |
| Fat or oil b | | 95.2 | 95.2 | 95.2 | 95.2 | 95.2 | 95.2 | 95.2 | 95.2 | 95.2 | 95.2 |
| (A) Ratio in | [mass | | | | | | | | | | |
| fat or oil | %] | | | | | | | | | | |
| C18:3 | | 20 | 20 | 20 | 20 | 20 | 20 | 20 | 20 | 20 | 20 |
| (B) RME-1 | [mass | 500 | 500 | 500 | 500 | 500 | 500 | 500 | 500 | 500 | 500 |
| | ppm] | | | | | | | | | | |
| (C1) SE-2 | [mass | 0.2 | 0.5 | 1 | 5 | 9 | 0 | 0 | 0 | 0 | 0 |
| | ppm] | | | | | | | | | | |
| (C1) SE-4 | [mass | 0 | 0 | 0 | 0 | 0 | 0.2 | 0.5 | 1 | 5 | 9 |
| | ppm] | | | | | | | | | | |
| (B)/(C18:3) | [mass | 0.0025 | 0.0025 | 0.0025 | 0.0025 | 0.0025 | 0.0025 | 0.0025 | 0.0025 | 0.0025 | 0.0025 |
| | ratio] | | | | | | | | | | |
| (C1)/(B) | [mass | 0.0004 | 0.0010 | 0.0020 | 0.0100 | 0.0180 | 0.0004 | 0.0010 | 0.0020 | 0.0100 | 0.0180 |
| | ratio] | | | | | | | | | | |

| | | | | | | | | | | |
|---|---|---|---|---|---|---|---|---|---|---|
| Odor derived from | 4 | 5 | 5 | 5 | 5 | 4 | 5 | 5 | 5 | 5 |
| rosemary extract | | | | | | | | | | |
| Odor derived from | 5 | 5 | 5 | 5 | 4 | 5 | 5 | 5 | 5 | 4 |
| plant extract | | | | | | | | | | |
| Degradation odor | 5 | 5 | 5 | 5 | 5 | 5 | 5 | 5 | 5 | 5 |
| due to oxidation | | | | | | | | | | |

As is apparent from the results shown in Table 8 or 9, in the fat or oil compositions of the present invention, it was confirmed that unpleasant odor peculiar to the rosemary extract was hardly sensed and degradation odor due to oxidation of the fat or oil at the time of heating was suppressed. In addition, the odor derived from the thyme extract or the basil extract was also hardly sensed.

### Examples 90 to 100 and Comparative Examples 16 to 20

### Preparation of Fat or Oil Compositions

The fat or oil a, the fat or oil b, the rosemary extract (RME-1), the clove extract (OE-1), and mixed tocopherols (manufactured by Archer Daniels Midland) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, the contents of the clove extract, and the contents of the mixed tocopherols in the fat or oil compositions are as shown in Table 10. It should be noted that the blending amounts of the rosemary extract and the clove extract in the preparations were determined from the contents of the extracts in the preparations shown in Tables 2 and 3 so as to achieve the contents shown in Table 10.

(Evaluation of Oxidative Stability)

The fat or oil compositions shown in Table 10 were used to evaluate oxidative stability. The oxidative stability was evaluated in accordance with “CDM test (2.5.1.2-1996)” described in “Standard Methods for the Analysis of Fats, Oils and Related Materials” edited by Japan Oil Chemists' Society by calculating induction time (hr), and the results were each represented as an oxidative stability index (OSI). The results are shown in Table 10.

(Thin Film Heating Test)

The fat or oil compositions shown in Table 10 were subjected to a thin film heating test. In the thin film heating test, 3 g of each of the fat or oil compositions was added to a stainless-steel petri dish with a diameter of 6 cm and placed on a hot plate heated to 150° C., and 10 minutes later, “degradation odor due to oxidation” was evaluated. Nine panelists evaluated their “degradation odor due to oxidation” in accordance with the following criteria, and mean values thereof were determined as scores. The results are shown in Table 10.

### (Degradation Odor Due to Oxidation)

5: Not sensed
4: Hardly not sensed
3: Slightly sensed

### 2: Sensed

1: Strongly sensed

TABLE 10

| | | Example | | | | | | | | |
|---|---|---|---|---|---|---|---|---|---|---|
| | | 90 | 91 | 92 | 93 | 94 | 95 | 96 | 97 | 98 |
| Fat or oil a | | 24.7 | 24.7 | 24.7 | 24.7 | 24.7 | 24.7 | 13.4 | 13.4 | 13.4 |
| Fat or oil b | | 75.3 | 75.3 | 75.3 | 75.3 | 75.3 | 75.3 | 86.6 | 86.6 | 86.6 |
| (A) Ratio in | [mass | | | | | | | | | |
| fat or oil | %] | | | | | | | | | |
| C18:3 | | 20 | 20 | 20 | 20 | 20 | 20 | 15 | 15 | 15 |
| (B) RME-1 | [mass | 100 | 300 | 500 | 800 | 1,000 | 2,000 | 100 | 250 | 500 |
| | ppm] | | | | | | | | | |
| (C2) OE-1 | [mass | 0.2 | 0.6 | 1 | 1.6 | 2 | 4 | 0.2 | 0.5 | 1 |
| | ppm] | | | | | | | | | |
| (B)/(C18:3) | [mass | 0.0005 | 0.0015 | 0.0025 | 0.0040 | 0.0050 | 0.0100 | 0.0007 | 0.0017 | 0.0033 |
| | ratio] | | | | | | | | | |
| (C2)/(B) | [mass | 0.0020 | 0.0020 | 0.0020 | 0.0020 | 0.0020 | 0.0020 | 0.0020 | 0.0020 | 0.0020 |
| | ratio] | | | | | | | | | |
| Mixed | [mass | — | — | — | — | — | — | — | — | — |
| tocopherols | ppm] | | | | | | | | | |

| | | | | | | | | | |
|---|---|---|---|---|---|---|---|---|---|
| OSI | 3 | 3.4 | 4.1 | 4.5 | 4.7 | 6 | 3.5 | 4.3 | 4.9 |
| Degradation odor | 4 | 5 | 5 | 5 | 5 | 5 | 5 | 5 | 5 |
| due to oxidation | | | | | | | | | |

| | | Example | | Comparative Example | | | | |
|---|---|---|---|---|---|---|---|---|
| | | 99 | 100 | 16 | 17 | 18 | 19 | 20 |
| Fat or oil a | | 47.2 | 69.8 | 13.4 | 24.7 | 47.2 | 69.8 | 24.7 |
| Fat or oil b | | 52.8 | 30.2 | 86.6 | 75.3 | 52.8 | 30.2 | 75.3 |
| (A) Ratio in | [mass | | | | | | | |
| fat or oil | %] | | | | | | | |
| C18:3 | | 30 | 40 | 15 | 20 | 30 | 40 | 20 |
| (B) RME-1 | [mass | 1,000 | 1,000 | 10 | 10 | 10 | 10 | 10 |
| | ppm] | | | | | | | |
| (C2) OE-1 | [mass | 2 | 2 | 0 | 0 | 0 | 0 | 0 |
| | ppm] | | | | | | | |
| (B)/(C18:3) | [mass | 0.0033 | 0.0025 | — | — | — | — | — |
| | ratio] | | | | | | | |
| (C2)/(B) | [mass | 0.0020 | 0.0020 | — | — | — | — | — |
| | ratio] | | | | | | | |
| Mixed | [mass | — | — | — | — | — | — | 1,000 |
| tocopherols | ppm] | | | | | | | |

| | | | | | | | |
|---|---|---|---|---|---|---|---|
| OSI | 3.8 | 3.5 | 3.1 | 2.6 | 1.8 | 1.4 | 3.0 |
| Degradation odor | 5 | 5 | 3 | 2 | 1 | 1 | 3 |
| due to oxidation | | | | | | | |

As is apparent from the results shown in Table 10, it was confirmed that the fat or oil compositions of the present invention have high oxidative stability and have suppressed degradation odor at the time of heating as well.

### Examples 101 to 120 and Comparative Examples 21 to 24

### Preparation of Fat or Oil Compositions

The fat or oil a, the fat or oil b, the rosemary extract (RME-1), and the clove extract (OE-1) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, and the contents of the clove extract in the fat or oil compositions are as shown in Table 11. It should be noted that the blending amounts of the rosemary extract and the clove extract in the preparations were determined from the contents of the extracts in the preparations shown in Tables 2 and 3 so as to achieve the contents shown in Table 11.

### Examples 121 to 127 and Comparative Examples 25 to 28

### Preparation of Fat or Oil Compositions

The fat or oil a, the fat or oil b, the rosemary extract (RME-1), and the oregano extract (OE-3) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, and the contents of the oregano extract in the fat or oil compositions are as shown in Table 12. It should be noted that the blending amounts of the rosemary extract and the oregano extract in the preparations were determined from the contents of the extracts in the preparations shown in Tables 2 and 3 so as to achieve the contents shown in Table 12.

### Examples 128 to 134 and Comparative Examples 29 to 32

### Preparation of Fat or Oil Compositions

The fat or oil a, the fat or oil b, the rosemary extract (RME-1), and the bay laurel extract (OE-4) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, and the contents of the bay laurel extract in the fat or oil compositions are as shown in Table 13. It should be noted that the blending amounts of the rosemary extract and the bay laurel extract in the preparations were determined from the contents of the extracts in the preparations shown in Tables 2 and 3 so as to achieve the contents shown in Table 13.

(Thin Film Heating Test)

The fat or oil compositions shown in Tables 11 to 13 were subjected to the thin film heating test in the same manner as above to evaluate the “degradation odor due to oxidation”. In addition, nine panelists evaluated their “odor derived from rosemary extract”, and “odor derived from clove extract”, “odor derived from oregano extract”, or “odor derived from bay laurel extract” (referred to as “odor derived from plant extract”) by the thin film heating test in the same manner as above in accordance with the following criteria, and mean values thereof were determined as scores. The results are shown in Tables 11 to 13.

(Odor Derived from Rosemary Extract)
5: Not sensed
4: Hardly not sensed
3: Slightly sensed

### 2: Sensed

1: Strongly sensed
(Odor Derived from Plant Extract)
5: Not sensed
4: Hardly not sensed
3: Slightly sensed

### 2: Sensed

1: Strongly sensed

TABLE 11

| | | Example | | | | | | | | |
|---|---|---|---|---|---|---|---|---|---|---|
| | | 101 | 102 | 103 | 104 | 105 | 106 | 107 | 108 | 109 |
| Fat or oil a | | 24.7 | 24.7 | 24.7 | 24.7 | 24.7 | 24.7 | 24.7 | 24.7 | 24.7 |
| Fat or oil b | | 75.3 | 75.3 | 75.3 | 75.3 | 75.3 | 75.3 | 75.3 | 75.3 | 75.3 |
| (A) Ratio in | [mass | | | | | | | | | |
| fat or oil | %] | | | | | | | | | |
| C18:3 | | 20 | 20 | 20 | 20 | 20 | 20 | 20 | 20 | 20 |
| (B) RME-1 | [mass | 100 | 300 | 300 | 300 | 300 | 500 | 500 | 500 | 500 |
| | ppm] | | | | | | | | | |
| (C2) OE-1 | [mass | 1 | 0.1 | 0.5 | 1 | 5 | 0.1 | 0.5 | 1 | 5 |
| | ppm] | | | | | | | | | |
| (B)/(C18:3) | [mass | 0.0005 | 0.0015 | 0.0015 | 0.0015 | 0.0015 | 0.0025 | 0.0025 | 0.0025 | 0.0025 |
| | ratio] | | | | | | | | | |
| (C2)/(B) | [mass | 0.0100 | 0.0003 | 0.0017 | 0.0033 | 0.0167 | 0.0002 | 0.0010 | 0.0020 | 0.0100 |
| | ratio] | | | | | | | | | |

| | | | | | | | | | |
|---|---|---|---|---|---|---|---|---|---|
| Odor derived from | 5 | 4 | 5 | 5 | 5 | 4 | 5 | 5 | 5 |
| rosemary extract | | | | | | | | | |
| Odor derived from | 4 | 5 | 5 | 5 | 4 | 5 | 5 | 5 | 5 |
| plant extract | | | | | | | | | |
| Degradation odor | 4 | 5 | 5 | 5 | 5 | 5 | 5 | 5 | 5 |
| due to oxidation | | | | | | | | | |

| | | Example | | | | | | | |
|---|---|---|---|---|---|---|---|---|---|
| | | 110 | 111 | 112 | 113 | 114 | 115 | 116 | 117 |
| Fat or oil a | | 24.7 | 24.7 | 24.7 | 24.7 | 24.7 | 24.7 | 24.7 | 24.7 |
| Fat or oil b | | 75.3 | 75.3 | 75.3 | 75.3 | 75.3 | 75.3 | 75.3 | 75.3 |
| (A) Ratio in | [mass | | | | | | | | |
| fat or oil | %] | | | | | | | | |
| C18:3 | | 20 | 20 | 20 | 20 | 20 | 20 | 20 | 20 |
| (B) RME-1 | [mass | 500 | 800 | 800 | 800 | 800 | 1,000 | 1,000 | 1,500 |
| | ppm] | | | | | | | | |
| (C2) OE-1 | [mass | 9 | 0.1 | 0.5 | 1 | 5 | 1 | 5 | 1 |
| | ppm] | | | | | | | | |
| (B)/(C18:3) | [mass | 0.0025 | 0.0040 | 0.0040 | 0.0040 | 0.0040 | 0.0050 | 0.0050 | 0.0075 |
| | ratio] | | | | | | | | |
| (C2)/(B) | [mass | 0.0180 | 0.0001 | 0.0006 | 0.0013 | 0.0063 | 0.0010 | 0.0050 | 0.0007 |
| | ratio] | | | | | | | | |

| | | | | | | | | |
|---|---|---|---|---|---|---|---|---|
| Odor derived from | 5 | 4 | 5 | 5 | 5 | 5 | 5 | 4 |
| rosemary extract | | | | | | | | |
| Odor derived from | 4 | 5 | 5 | 5 | 5 | 5 | 5 | 5 |
| plant extract | | | | | | | | |
| Degradation odor | 5 | 5 | 5 | 5 | 5 | 5 | 5 | 5 |
| due to oxidation | | | | | | | | |

| | | Example | | | Comparative Example | | | |
|---|---|---|---|---|---|---|---|---|
| | | 118 | 119 | 120 | 21 | 22 | 23 | 24 |
| Fat or oil a | | 24.7 | 24.7 | 24.7 | 4.8 | 4.8 | 4.8 | 4.8 |
| Fat or oil b | | 75.3 | 75.3 | 75.3 | 95.2 | 95.2 | 95.2 | 95.2 |
| (A) Ratio in | [mass | | | | | | | |
| fat or oil | %] | | | | | | | |
| C18:3 | | 20 | 20 | 20 | 20 | 20 | 20 | 20 |
| (B) RME-1 | [mass | 1,500 | 2,000 | 2,000 | 0 | 500 | 500 | 3,000 |
| | ppm] | | | | | | | |
| (C2) OE-1 | [mass | 5 | 1 | 5 | 1 | 0.001 | 40 | 1 |
| | ppm] | | | | | | | |
| (B)/(C18:3) | [mass | 0.0075 | 0.0100 | 0.0100 | — | 0.0025 | 0.0025 | 0.0150 |
| | ratio] | | | | | | | |
| (C2)/(B) | [mass | 0.0033 | 0.0005 | 0.0025 | — | 0.000002 | 0.0800 | 0.0003 |
| | ratio] | | | | | | | |

| | | | | | | | |
|---|---|---|---|---|---|---|---|
| Odor derived from | 5 | 4 | 4 | 5 | 2 | 5 | 2 |
| rosemary extract | | | | | | | |
| Odor derived from | 5 | 5 | 5 | 3 | 5 | 1 | 5 |
| plant extract | | | | | | | |
| Degradation odor | 5 | 5 | 5 | 2 | 5 | 5 | 5 |
| due to oxidation | | | | | | | |

TABLE 12

| | | Example | | | | | | |
|---|---|---|---|---|---|---|---|---|
| | | 121 | 122 | 123 | 124 | 125 | 126 | 127 |
| Fat or oil a | | 24.7 | 24.7 | 24.7 | 24.7 | 24.7 | 24.7 | 24.7 |
| Fat or oil b | | 75.3 | 75.3 | 75.3 | 75.3 | 75.3 | 75.3 | 75.3 |
| (A) Ratio in | [mass | | | | | | | |
| fat or oil | %] | | | | | | | |
| C18:3 | | 20 | 20 | 20 | 20 | 20 | 20 | 20 |
| (B) RME-1 | [mass | 300 | 300 | 500 | 500 | 500 | 1,000 | 1,000 |
| | ppm] | | | | | | | |
| (C2) OE-3 | [mass | 1 | 5 | 1 | 5 | 9 | 1 | 5 |
| | ppm] | | | | | | | |
| (B)/(C18:3) | [mass | 0.0015 | 0.0015 | 0.0025 | 0.0025 | 0.0025 | 0.0050 | 0.0050 |
| | ratio] | | | | | | | |
| (C2)/(B) | [mass | 0.0033 | 0.0167 | 0.0020 | 0.010 | 0.0180 | 0.0010 | 0.0050 |
| | ratio] | | | | | | | |

| | | | | | | | |
|---|---|---|---|---|---|---|---|
| Odor derived from | 5 | 5 | 5 | 5 | 5 | 5 | 5 |
| rosemary extract | | | | | | | |
| Odor derived from | 5 | 4 | 5 | 4 | 4 | 5 | 4 |
| plant extract | | | | | | | |
| Degradation odor | 5 | 5 | 5 | 5 | 5 | 5 | 5 |
| due to oxidation | | | | | | | |

| | | Comparative Example | | | |
|---|---|---|---|---|---|
| | | 25 | 26 | 27 | 28 |
| Fat or oil a | | 24.7 | 24.7 | 24.7 | 24.7 |
| Fat or oil b | | 75.3 | 75.3 | 75.3 | 75.3 |
| (A) Ratio in | [mass | | | | |
| fat or oil | %] | | | | |
| C18:3 | | 20 | 20 | 20 | 20 |
| (B) RME-1 | [mass | 0 | 500 | 500 | 3,000 |
| | ppm] | | | | |
| (C2) OE-3 | [mass | 1 | 0.001 | 40 | 1 |
| | ppm] | | | | |
| (B)/(C18:3) | [mass | — | 0.0025 | 0.0025 | 0.0150 |
| | ratio] | | | | |
| (C2)/(B) | [mass | — | 0.000002 | 0.0800 | 0.0003 |
| | ratio] | | | | |

| | | | | |
|---|---|---|---|---|
| Odor derived from | 5 | 2 | 5 | 2 |
| rosemary extract | | | | |
| Odor derived from | 2 | 5 | 1 | 5 |
| plant extract | | | | |
| Degradation odor | 2 | 5 | 5 | 5 |
| due to oxidation | | | | |

TABLE 13

| | | Example | | | | | | |
|---|---|---|---|---|---|---|---|---|
| | | 128 | 129 | 130 | 131 | 132 | 133 | 134 |
| Fat or oil a | | 24.7 | 24.7 | 24.7 | 24.7 | 24.7 | 24.7 | 24.7 |
| Fat or oil b | | 75.3 | 75.3 | 75.3 | 75.3 | 75.3 | 75.3 | 75.3 |
| (A) Ratio in | [mass | | | | | | | |
| fat or oil | %] | | | | | | | |
| C18:3 | | 20 | 20 | 20 | 20 | 20 | 20 | 20 |
| (B) RME-1 | [mass | 300 | 300 | 500 | 500 | 500 | 1,000 | 1,000 |
| | ppm] | | | | | | | |
| (C2) OE-4 | [mass | 1 | 5 | 1 | 5 | 9 | 1 | 5 |
| | ppm] | | | | | | | |
| (B)/(C18:3) | [mass | 0.0015 | 0.0015 | 0.0025 | 0.0025 | 0.0025 | 0.005 | 0.005 |
| | ratio] | | | | | | | |
| (C2)/(B) | [mass | 0.0033 | 0.0167 | 0.0020 | 0.0100 | 0.0180 | 0.0010 | 0.0050 |
| | ratio] | | | | | | | |

| | | | | | | | |
|---|---|---|---|---|---|---|---|
| Odor derived from | 5 | 5 | 5 | 5 | 5 | 4 | 4 |
| rosemary extract | | | | | | | |
| Odor derived from | 4 | 4 | 4 | 4 | 3 | 4 | 4 |
| plant extract | | | | | | | |
| Degradation odor | 5 | 5 | 5 | 5 | 5 | 5 | 5 |
| due to oxidation | | | | | | | |

| | | Comparative Example | | | |
|---|---|---|---|---|---|
| | | 29 | 30 | 31 | 32 |
| Fat or oil a | | 24.7 | 24.7 | 24.7 | 24.7 |
| Fat or oil b | | 75.3 | 75.3 | 75.3 | 75.3 |
| (A) Ratio in | [mass | | | | |
| fat or oil | %] | | | | |
| C18:3 | | 20 | 20 | 20 | 20 |
| (B) RME-1 | [mass | 0 | 500 | 500 | 3,000 |
| | ppm] | | | | |
| (C2) OE-4 | [mass | 1 | 0.001 | 40 | 1 |
| | ppm] | | | | |
| (B)/(C18:3) | [mass | — | 0.0025 | 0.0025 | 0.0150 |
| | ratio] | | | | |
| (C2)/(B) | [mass | — | 0.000002 | 0.0800 | 0.0003 |
| | ratio] | | | | |

| | | | | |
|---|---|---|---|---|
| Odor derived from | 5 | 2 | 5 | 2 |
| rosemary extract | | | | |
| Odor derived from | 3 | 5 | 1 | 5 |
| plant extract | | | | |
| Degradation odor | 2 | 5 | 5 | 5 |
| due to oxidation | | | | |

As is apparent from the results shown in Tables 11 to 13, it was confirmed that the fat or oil compositions of the present invention have less unpleasant odor peculiar to the rosemary extract and had suppressed degradation odor due to oxidation of the fat or oil at the time of heating. In addition, the odor derived from the clove extract, the oregano extract, or the bay laurel extract was also hardly sensed.

### Examples 135 to 140 and Comparative Examples 33 and 34

### Preparation of Fat or Oil Compositions

The fat or oil a, the fat or oil b, the rosemary extract (RME-1), and the clove extract (OE-1) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, and the contents of the clove extract in the fat or oil compositions are as shown in Table 14. It should be noted that the blending amounts of the rosemary extract and the clove extract in the preparations were determined from the contents of the extracts in the preparations shown in Tables 2 and 3 so as to achieve the contents shown in Table 14.

(Thin Film Heating Test)

The fat or oil compositions shown in Table 14 were subjected to the thin film heating test in the same manner as above to evaluate the “degradation odor due to oxidation”. In addition, nine panelists evaluated their “odor derived from rosemary extract” and “odor derived from clove extract” (referred to as “odor derived from plant extract”) by the thin film heating test in the same manner as above in accordance with the above-mentioned criteria, and mean values thereof were determined as scores. The results are shown in Table 14.

TABLE 14

| | | | | | | | | Comparative | |
|---|---|---|---|---|---|---|---|---|---|
| | | Example | | | | | | Example | |
| | | 135 | 136 | 137 | 138 | 139 | 140 | 33 | 34 |
| Fat or oil a | | 47.2 | 47.2 | 47.2 | 69.8 | 69.8 | 69.8 | 47.2 | 69.8 |
| Fat or oil b | | 52.8 | 52.8 | 52.8 | 30.2 | 30.2 | 30.2 | 52.8 | 30.2 |
| (A) Ratio in | [mass | | | | | | | | |
| fat or oil | %] | | | | | | | | |
| C18:3 | | 30 | 30 | 30 | 40 | 40 | 40 | 30 | 40 |
| (B) RME-1 | [mass | 500 | 1,000 | 2,000 | 500 | 1,000 | 2,000 | 10 | 10 |
| | ppm] | | | | | | | | |
| (C2) OE-1 | [mass | 1 | 1 | 1 | 1 | 1 | 1 | 1 | 1 |
| | ppm] | | | | | | | | |
| (B)/(C18:3) | [mass | 0.0017 | 0.0033 | 0.0067 | 0.0013 | 0.0025 | 0.0050 | 0.00003 | 0.00003 |
| | ratio] | | | | | | | | |
| (C2)/(B) | [mass | 0.0020 | 0.0010 | 0.0005 | 0.0020 | 0.0010 | 0.0005 | 0.1000 | 0.1000 |
| | ratio] | | | | | | | | |

| | | | | | | | | |
|---|---|---|---|---|---|---|---|---|
| Odor derived from | 5 | 5 | 5 | 5 | 5 | 5 | 5 | 5 |
| rosemary extract | | | | | | | | |
| Odor derived from | 5 | 5 | 5 | 5 | 5 | 5 | 4 | 4 |
| plant extract | | | | | | | | |
| Degradation odor | 4 | 5 | 5 | 4 | 4 | 5 | 2 | 2 |
| due to oxidation | | | | | | | | |

As is apparent from the results shown in Table 14, in the fat or oil compositions of the present invention, unpleasant odor peculiar to the rosemary extract was hardly sensed and degradation odor due to oxidation of the fat or oil at the time of heating was suppressed. In addition, the odor derived from the clove extract was also hardly sensed.

### Examples 141 to 150

### Preparation of Fat or Oil Compositions

The fat or oil a, the fat or oil b, the rosemary extract (RME-1 or RME-2), the clove extract (OE-1 or OE-2), and the bay laurel extract (OE-5) were mixed to prepare fat or oil compositions, respectively. The contents of α-linolenic acid (C18:3) in constituent fatty acids of the fats or oils in the fat or oil compositions (total amount: 100 mass %), and the contents of the rosemary extract, the contents of the clove extract, and the contents of the bay laurel extract in the fat or oil compositions are as shown in Table 15 or 16. It should be noted that the blending amounts of the rosemary extract, the clove extract, and the bay laurel extract in the preparations were determined from the contents of the extracts in the preparations shown in Tables 2 and 3 so as to achieve the contents shown in Table 15 or 16.

(Thin Film Heating Test)

The fat or oil compositions shown in Table 15 or 16 were subjected to the thin film heating test in the same manner as above to evaluate the “degradation odor due to oxidation”. In addition, nine panelists evaluated their “odor derived from rosemary extract”, and “odor derived from clove extract” or “odor derived from bay laurel extract” (referred to as “odor derived from plant extract”) by the thin film heating test in the same manner as above in accordance with the above-mentioned criteria, and mean values thereof were determined as scores. The results are shown in Table 15 or 16.

TABLE 15

| | | Example | | |
|---|---|---|---|---|
| | | 141 | 142 | 143 |
| Fat or oil a | | 4.8 | 4.8 | 4.8 |
| Fat or oil b | | 95.2 | 95.2 | 95.2 |
| (A) Ratio in | [mass | | | |
| fat or oil | %] | | | |
| C18:3 | | 20 | 20 | 20 |
| (B) RME-2 | [mass | 500 | 500 | 500 |
| | ppm] | | | |
| (C2) OE-1 | [mass | 0.1 | 1 | 5 |
| | ppm] | | | |
| (B)/(C18:3) | [mass | 0.0025 | 0.0025 | 0.0025 |
| | ratio] | | | |
| (C2)/(B) | [mass | 0.0002 | 0.0020 | 0.0100 |
| | ratio] | | | |

| | | | |
|---|---|---|---|
| Odor derived from | 5 | 5 | 5 |
| rosemary extract | | | |
| Odor derived from | 5 | 5 | 4 |
| plant extract | | | |
| Degradation odor | 5 | 5 | 5 |
| due to oxidation | | | |

TABLE 16

| | | Example | | | | | | |
|---|---|---|---|---|---|---|---|---|
| | | 144 | 145 | 146 | 147 | 148 | 149 | 150 |
| Fat or oil a | | 4.8 | 4.8 | 4.8 | 4.8 | 4.8 | 4.8 | 4.8 |
| Fat or oil b | | 95.2 | 95.2 | 95.2 | 95.2 | 95.2 | 95.2 | 95.2 |
| (A) Ratio in | [mass | | | | | | | |
| fat or oil | %] | | | | | | | |
| C18:3 | | 20 | 20 | 20 | 20 | 20 | 20 | 20 |
| (B) RME-1 | [mass | 500 | 500 | 500 | 500 | 500 | 500 | 500 |
| | ppm] | | | | | | | |
| (C2) OE-2 | [mass | 0.1 | 0.5 | 1 | 5 | — | — | — |
| | ppm] | | | | | | | |
| (C2) OE-5 | [mass | — | — | — | — | 0.1 | 1 | 5 |
| | ppm] | | | | | | | |
| (B)/(C18:3) | [mass | 0.0025 | 0.0025 | 0.0025 | 0.0025 | 0.0025 | 0.0025 | 0.0025 |
| | ratio] | | | | | | | |
| (C2)/(B) | [mass | 0.0002 | 0.0010 | 0.0020 | 0.0100 | 0.0002 | 0.0020 | 0.0100 |
| | ratio] | | | | | | | |

| | | | | | | | |
|---|---|---|---|---|---|---|---|
| Odor derived from | 4 | 5 | 5 | 5 | 4 | 5 | 5 |
| rosemary extract | | | | | | | |
| Odor derived from | 5 | 5 | 5 | 4 | 5 | 5 | 4 |
| plant extract | | | | | | | |
| Degradation odor | 5 | 5 | 5 | 5 | 5 | 5 | 5 |
| due to oxidation | | | | | | | |

As is apparent from the results shown in Table 15 or 16, in the fat or oil compositions of the present invention, unpleasant odor peculiar to the rosemary extract was hardly sensed and degradation odor due to oxidation of the fat or oil at the time of heating was suppressed. In addition, the odor derived from the clove extract or the bay laurel extract was also hardly sensed.

1-13. (canceled)

14: A fat or oil composition, comprising components (A), (B), and (C1):
(A) a fat or oil in which an amount of α-linolenic acid in constituent fatty acids of the fat or oil is from 15 to 60 mass %;
(B) a rosemary extract in an amount of from 0.005 to 0.25 mass %; and
(C1) a thyme extract, a basil extract, or a combination thereof in an amount of from 0.00001 to 0.0025 mass %.

15: The fat or oil composition according to claim 14, wherein a mass ratio of the amount of component (C1) to the amount of the rosemary extract as component (B), [(C1)/(B)], is from 0.0003 to 0.08.

16: A fat or oil composition, comprising components (A), (B), and (C2):
(A) a fat or oil in which an amount of α-linolenic acid in constituent fatty acids of the fat or oil is from 15 to 60 mass %;
(B) a rosemary extract in an amount of from 0.005 to 0.25 mass %; and
(C2) at least one member selected from the group consisting of a clove extract, an oregano extract, and a bay laurel extract at a content of from 0.00001 to 0.001 mass %.

17: The fat or oil composition according to claim 16, wherein a mass ratio of the amount of component (C2) to the amount of the rosemary extract as component (B), [(C2)/(B)], is from 0.0001 to 0.03.

18: The fat or oil composition according to claim 14, wherein a mass ratio of the amount of the rosemary extract as the component (B) in the fat or oil composition to the amount of the α-linolenic acid in the constituent fatty acids of the fat or oil as component (A), [(B)/(C18:3)], is from 0.0002 to 0.015.

19: The fat or oil composition according to claim 14, wherein component (A) comprises at least one of member selected from the group consisting of linseed oil, Japanese basil oil, and perilla oil.

20: The fat or oil composition according to claim 14, wherein the amount of the rosemary extract as component (B) is from 0.01 to 0.2 mass %.

21: The fat or oil composition according to claim 14, comprising from 95 to 99.95 mass % of the fat or oil as the component (A).

22: The fat or oil composition according to claim 14, wherein an amount of triacylglycerols in the fat or oil as the component (A) is from 78 to 100 mass %.

23: The fat or oil composition according to claim 14, wherein a ratio of unsaturated fatty acids in the constituent fatty acids of the fat or oil as the component (A) other than α-linolenic acid is from 60 to 100 mass %.

24: The fat or oil composition according to claim 14, further comprising at least one antioxidant selected from the group consisting of a natural antioxidant, a tocopherol, and an ascorbic acid ester.

25: The fat or oil composition according to claim 24, wherein an amount of the antioxidant is from 0.01 to 0.2 mass %.

26: A method of improving oxidative stability of a fat or oil composition according to claim 14, comprising blending a rosemary extract as a component (B) and a thyme extract, a basil extract, or a combination thereof as a component (C1) into a fat or oil composition comprising, as a component (A), a fat or oil in which an amount of α-linolenic acid in constituent fatty acids of the fat or oil is from 15 to 60 mass %, so that the amount of the rosemary extract as the component (B) is from 0.005 to 0.25 mass % and the amount of the thyme extract, the basil extract, or the combination thereof as the component (C1) is from 0.00001 to 0.0025 mass %.

27: A method of improving oxidative stability of a fat or oil composition according to claim 16, comprising blending a rosemary extract as a component (B) and at least one member, as a component (C2), selected from the group consisting of a clove extract, an oregano extract, and a bay laurel extract into a fat or oil composition comprising, as a component (A), a fat or oil in which an amount of α-linolenic acid in constituent fatty acids of the fat or oil is from 15 to 60 mass %, so that the amount of the rosemary extract as the component (B) is from 0.005 to 0.25 mass % and the content of at least one member, as the component (C2), selected from the group consisting of the clove extract, the oregano extract, and the bay laurel extract is from 0.00001 to 0.001 mass %.

28: A method of suppressing odor of a rosemary extract from a fat or oil composition according to claim 14, comprising blending a thyme extract, a basil extract, or a combination thereof as a component (C1) into a fat or oil composition comprising the rosemary extract as the component (B) in an amount of from 0.005 to 0.25 mass % and comprising, as a component (A), a fat or oil in which an amount of α-linolenic acid in constituent fatty acids of the fat or oil is from 15 to 60 mass %, so that the amount of the thyme extract, the basil extract, or the combination thereof as the component (C1) is from 0.00001 to 0.0025 mass %.

29: A method of suppressing odor of a rosemary extract from a fat or oil composition according to claim 16, comprising blending at least one member, as a component (C2), selected from the group consisting of a clove extract, an oregano extract, and a bay laurel extract into a fat or oil composition comprising the rosemary extract as the component (B) in an amount of from 0.005 to 0.25 mass % and comprising, as a component (A), a fat or oil in which an amount of α-linolenic acid in constituent fatty acids of the fat or oil is from 15 to 60 mass %, so that the amount of at least one member, as the component (C2), selected from the group consisting of the clove extract, the oregano extract, and the bay laurel extract is from 0.00001 to 0.001 mass %.

30: The fat or oil composition according to claim 16, wherein a mass ratio of the amount of the rosemary extract as the component (B) in the fat or oil composition to the amount of the α-linolenic acid in the constituent fatty acids of the fat or oil as component (A), [(B)/(C18:3)], is from 0.0002 to 0.015.

31: The fat or oil composition according to claim 16, wherein component (A) comprises at least one of member selected from the group consisting of linseed oil, Japanese basil oil, and perilla oil.

32: The fat or oil composition according to claim 16, wherein the amount of the rosemary extract as component (B) is from 0.01 to 0.2 mass %.

33: The fat or oil composition according to claim 16, comprising from 95 to 99.95 mass % of the fat or oil as the component (A).

34: The fat or oil composition according to claim 16, wherein an amount of triacylglycerols in the fat or oil as the component (A) is from 78 to 100 mass %.

35: The fat or oil composition according to claim 16, wherein a ratio of unsaturated fatty acids in the constituent fatty acids of the fat or oil as the component (A) other than α-linolenic acid is from 60 to 100 mass %.

36: The fat or oil composition according to claim 16, further comprising at least one antioxidant selected from the group consisting of a natural antioxidant, a tocopherol, and an ascorbic acid ester.

37: The fat or oil composition according to claim 36, wherein an amount of the antioxidant is from 0.01 to 0.2 mass %.
